(19) United States
(12) Patent Application Publication
(10) Pub. No.: US 2023/0348315 A1
(43) Pub. Date: Nov. 2, 2023

(54) GLASS PLATE, LAMINATED GLASS, WINDOW GLASS FOR BUILDING, AND WINDOW GLASS FOR VEHICLE

(71) Applicant: AGC Inc., Tokyo (JP)

(72) Inventors: Takato KAJIHARA, Tokyo (JP); Shigeki SAWAMURA, Tokyo (JP); Rikiya KADO, Tokyo (JP); Yutaka KUROIWA, Tokyo (JP); Shusaku AKIBA, Tokyo (JP)

(73) Assignee: AGC Inc., Tokyo (JP)

(21) Appl. No.: 18/331,230

(22) Filed: Jun. 8, 2023

Related U.S. Application Data
(63) Continuation of application No. PCT/JP2021/046158, filed on Dec. 14, 2021.

(30) Foreign Application Priority Data
Dec. 18, 2020 (JP) 2020-210647

(51) Int. Cl. C03C 3/089; C03C 3/097; C03C 3/087; C03C 3/091; C03C 3/093; B32B 17/10

(52) U.S. Cl. CPC C03C 3/097; B32B 17/10036; B32B 17/1055; C03C 3/087; C03C 3/089; C03C 3/091; C03C 3/093; B32B 2307/204; B32B 2307/412; B32B 2307/54; B32B 2307/72; B32B 2307/734; B32B 2307/7376; B32B 2605/00

(57) ABSTRACT

A glass plate includes, in terms of molar percentage based on oxides: 50% ≤ SiO₂ ≤ 80%; 5.0% ≤ Al₂O₃ ≤ 10%; 5.0% < B₂O₃ ≤ 15%; 0.0% ≤ P₂O₅ ≤ 10%; 0.0% ≤ MgO ≤ 10%; 0.0% ≤ CaO ≤ 10%; 0.0% ≤ SrO ≤ 10%; 0.0% ≤ BaO ≤ 10%; 0.0% ≤ ZnO ≤ 5.0%; 0.0% ≤ Li₂O ≤ 5.0%; 0.0% ≤ Na₂O ≤ 5.0%; 0.0% ≤ K₂O ≤ 5.0%; 0.0% ≤ R₂O ≤ 5.0%; Fe₂O₃ ≥ 0.04%; 15% ≤ RO ≤ 30%; B₂O₃ - Al₂O₃ > 0.0%; and 0.30 < Al₂O₃/RO < 0.50, in which the glass plate has a temperature T₁₂ at which a glass viscosity is 10¹² dPa·s of 730° C. or lower, and the glass plate has an average thermal expansion coefficient at 50° C. to 350° C. of 40 × 10⁻⁷/K or more.

### CROSS-REFERENCE TO RELATED APPLICATIONS

This is a bypass continuation of International Patent Application No. PCT/JP2021/046158, filed on Dec. 14, 2021, which claims priority to Japanese Patent Application No. 2020-210647, filed on Dec. 18, 2020. The contents of these applications are hereby incorporated by reference in their entireties.

### TECHNICAL FIELD

The present invention relates to a glass plate, a laminated glass, a window glass for building, and a window glass for vehicle.

### BACKGROUND ART

In recent years, high-speed and large-capacity data communication is expected to spread in the future, such as construction of a communication infrastructure by 4G LTE and 5G, and communication by a millimeter wave radar of 30 GHz or more, including autonomous driving.

However, when such a millimeter wave radar is installed in a vehicle or a building and a millimeter radio wave is transmitted through a window glass, a window glass for vehicle and a window glass for building in the related art have low millimeter wave transmissibility, and thus are not suitable as a next generation glass. This is due to poor dielectric properties of a soda lime glass which is currently used in many window glasses for vehicle and window glasses for building.

On the other hand, examples of a glass having high radio wave transmissibility in 5G communication using a millimeter wave include a glass composition such as an alkali-free glass or a low-alkali glass. For example, Patent Literature 1 discloses an alkali-free glass composition used for producing a liquid crystal display device.

Patent Literature 1: JPH07-300336A

### SUMMARY OF INVENTION

However, when a glass composition such as an alkali-free glass or a low-alkali glass is used to produce a glass plate that requires a bending forming process, such as a curved windshield for automobile or a curved window glass for building with a design, forming at a high temperature is required as compared with a soda lime glass. The glass composition disclosed in Patent Literature 1 is assumed to be used for producing a liquid crystal display device, and it is not assumed that a glass substrate made of the glass composition is bent. Therefore, when the glass substrate is bent, forming at a high temperature is required.

In addition, a glass composition such as an alkali-free glass or a low-alkali glass having a high radio wave transmittance for 5G communication of a millimeter wave radar or the like, also has a problem that it is difficult to apply thermal strengthening when the glass composition is assumed to be used as a window glass for building or a side glass for an automobile.

In view of the above problems, the present invention is to provide a glass plate and a laminated glass which have a high millimeter wave transmittance and a low bending forming temperature, and is further to provide a window glass for building and a window glass for vehicle including the glass plate or the laminated glass.

A glass plate according to an embodiment of the present invention including, in terms of molar percentage based on oxides:
50% ≤ SiO₂ ≤ 80%;
5.0% ≤ Al₂O₃ ≤ 10%;
5.0% < B₂O₃ ≤ 15%;
0.0% ≤ P₂O₅ ≤ 10%;
0.0% ≤ MgO ≤ 10%;
0.0% ≤ CaO ≤ 10%;
0.0% ≤ SrO ≤ 10%;
0.0% ≤ BaO ≤ 10%;
0.0% ≤ ZnO ≤ 5.0%;
0.0% ≤ Li₂O ≤ 5.0%;
0.0% ≤ Na₂O ≤ 5.0%;
0.0% ≤ K₂O ≤ 5.0%;
0.0% ≤ R₂O ≤ 5.0%;
Fe₂O₃ ≥ 0.04%;
15% ≤ RO ≤ 30%;
B₂O₃ - Al₂O₃ > 0.0%; and
0.30 < Al₂O₃/RO < 0.50
(where R₂O represents a total amount of Li₂O, Na₂O, and K₂O, and RO represents a total amount of MgO, CaO, SrO, and BaO), in which
   the glass plate has a temperature T₁₂ at which a glass viscosity is 10¹² dPa·s of 730° C. or lower, and
   the glass plate has an average thermal expansion coefficient at 50° C. to 350° C. of 40 × 10⁻⁷/K or more.

In a glass plate according to one aspect of the present invention, the temperature T₁₂ may be 720° C. or lower.

In a glass plate according to one aspect of the present invention, a relative dielectric constant (εᵣ) at a frequency of 10 GHz may be 6.5 or less.

In a glass plate according to one aspect of the present invention, a dielectric loss tangent (tan δ) at a frequency of 10 GHz may be 0.0090 or less.

In a glass plate according to one aspect of the present invention, when a thickness of the glass plate is converted into 2.00 mm, a visible light transmittance Tv defined by ISO-9050:2003 using a D65 light source may be 75% or more.

In a glass plate according to one aspect of the present invention, when a thickness of the glass plate is converted into 2.00 mm, a total solar transmittance Tts defined by ISO-13837:2008 convention A and measured at a wind speed of 4 m/s may be 88% or less.

In a glass plate according to one aspect of the present invention, the total solar transmittance Tts may be 80% or less.

A glass plate according to one aspect of the present invention may further includes, in terms of molar percentage based on oxides:
55% ≤ SiO₂ ≤ 70%;
6.0% ≤ Al₂O₃ ≤ 8.0%;
7.0% ≤ B₂O₃ ≤ 12%;
0.0% ≤ P₂O₅ ≤ 5.0%;
2.0% ≤ MgO ≤ 7.0%;
2.0% ≤ CaO ≤ 7.0%;
2.0% ≤ SrO ≤ 7.0%;
2.0% ≤ BaO ≤ 7.0%;
0.0% ≤ ZnO ≤ 3.0%;
0.04% ≤ Fe₂O₃ ≤ 0.50%;
16% ≤ RO ≤ 25%; and
0.0% ≤ R₂O ≤ 3.0%.

A glass plate according to one aspect of the present invention may be a thermal strengthened glass.

A laminated glass according to an embodiment of the present invention includes: a first glass plate; a second glass plate; and an interlayer sandwiched between the first glass plate and the second glass plate, in which at least one of the first glass plate and the second glass plate is the above glass plate.

In a laminated glass according to one aspect of the present invention, a total thickness of the first glass plate, the second glass plate, and the interlayer may be 5.00 mm or less, and a visible light transmittance Tv defined by ISO-9050:2003 using a D65 light source may be 70% or more.

In a laminated glass according to one aspect of the present invention, a total thickness of the first glass plate, the second glass plate, and the interlayer may be 5.00 mm or less, and a total solar transmittance Tts defined by ISO-13837:2008 convention A and measured at a wind speed of 4 m/s may be 70% or less.

In a laminated glass according to one aspect of the present invention, a total thickness of the first glass plate, the second glass plate, and the interlayer may be 5.00 mm or less, and a maximum value of a radio wave transmission loss S21 when a TM radio wave having a frequency of 75 GHz to 80 GHz is incident on the first glass plate at an incident angle of 60° may be -4.0 dB or more.

In a laminated glass according to one aspect of the present invention, a total thickness of the first glass plate, the second glass plate, and the interlayer may be 5.00 mm or less, and a maximum value of a radio wave transmission loss S21 when a TM radio wave having a frequency of 75 GHz to 80 GHz is incident on the first glass plate at an incident angle of 45° may be -4.0 dB or more.

In a laminated glass according to one aspect of the present invention, a total thickness of the first glass plate, the second glass plate, and the interlayer may be 5.00 mm or less, and a maximum value of a radio wave transmission loss S21 when a TM radio wave having a frequency of 75 GHz to 80 GHz is incident on the first glass plate at an incident angle of 20° may be -4.0 dB or more.

A window glass for building according to an embodiment of the present invention includes the above glass plate.

A window glass for vehicle according to an embodiment of the present invention includes the above glass plate.

A window glass for vehicle according to another embodiment of the present invention includes the above laminated glass.

According to the present invention, it is possible to provide a glass plate and a laminated glass which have a high millimeter wave transmittance and a low bending forming temperature, and is further to provide a window glass for building and a window glass for vehicle including the glass plate or the laminated glass.

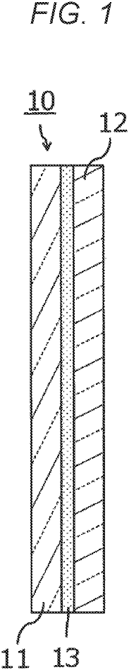

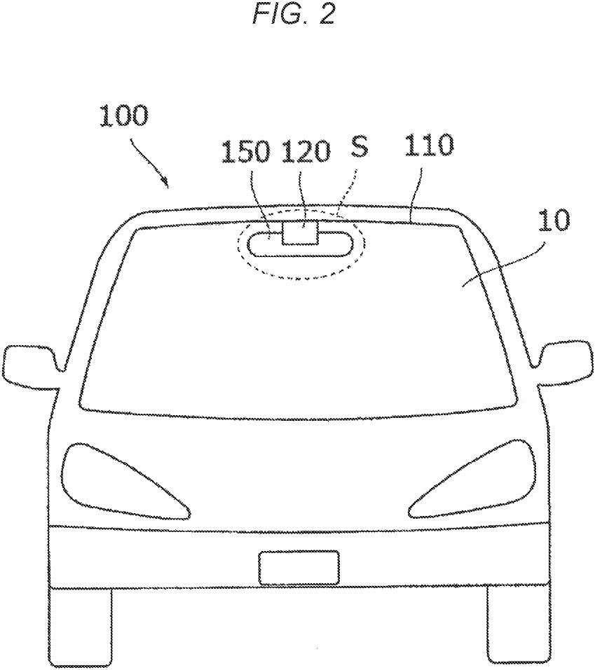

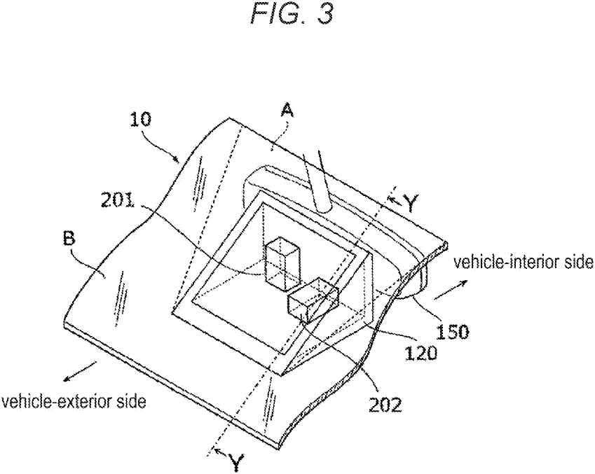

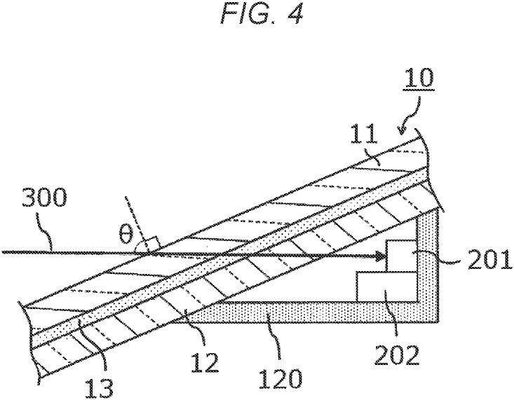

### BRIEF DESCRIPTION OF DRAWINGS

[FIG. 1] FIG. 1 is a cross-sectional view of an example of a laminated glass according to an embodiment of the present invention.

[FIG. 2] FIG. 2 is a conceptual view illustrating a state in which a laminated glass of an embodiment of the present invention is used as a window glass for vehicle.

[FIG. 3] FIG. 3 is an enlarged view of a portion S illustrated in FIG. 2.

[FIG. 4] FIG. 4 is a cross-sectional view taken along a line Y-Y in FIG. 3.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematically for the purpose of clearly explaining the present invention, and do not necessarily accurately represent a size or a scale of an actual product.

In the present description, unless otherwise specified, an evaluation such as “high/low radio wave (millimeter wave) transmissibility” means an evaluation for radio wave (including quasi-millimeter wave and millimeter wave) transmissibility, and means, for example, radio wave transmissibility of a glass with respect to a radio wave having a frequency of 10 GHz to 90 GHz.

In the present description, the expression that a glass “is substantially free of” a component means that the component is not contained except for inevitable impurities, and means that the component is not positively added. Specifically, the expression means that a content of each of these components in the glass is about 100 ppm or less in terms of molar ppm based on oxides.

### Glass Plate

A glass plate according to an embodiment of the present invention includes, in terms of molar percentage based on oxides:
50% ≤ SiO₂ ≤ 80%;
5.0% ≤ Al₂O₃ ≤ 10%;
5.0% < B₂O₃ ≤ 15%;
0.0% ≤ P₂O₅ ≤ 10%;
0.0% ≤ MgO ≤ 10%;
0.0% ≤ CaO ≤ 10%;
0.0% ≤ SrO ≤ 10%;
0.0% ≤ BaO ≤ 10%;
0.0% ≤ ZnO ≤ 5.0%;
0.0% ≤ Li₂O ≤ 5.0%;
0.0% ≤ Na₂O ≤ 5.0%;
0.0% ≤ K₂O ≤ 5.0%;
0.0% ≤ R₂O ≤ 5.0%;
Fe₂O₃ ≥ 0.04%;
15% ≤ RO ≤ 30%;
B₂O₃ - Al₂O₃ > 0.0%; and
0.30 < Al₂O₃/RO < 0.50;
(where R₂O represents a total amount of Li₂O, Na₂O, and K₂O, and RO represents a total amount of MgO, CaO, SrO, and BaO).

The glass plate has a temperature T₁₂ at which a glass viscosity is 10¹² dPa·s of 730° C. or lower.

The glass plate has an average thermal expansion coefficient at 50° C. to 350° C. of 40 × 10⁻⁷/K or more.

Hereinafter, a composition range of each component contained in the glass plate of the present embodiment will be described. Hereinafter, the composition range of each component is expressed in terms of molar percentage based on oxides unless otherwise specified.

SiO₂ is an essential component of the glass plate of the present embodiment. A content of SiO₂ is 50% or more and 80% or less. SiO₂ contributes to an increase in Young’s modulus, thereby making it easier to ensure a strength required for vehicle applications, building applications, and the like. In the case where the content of SiO₂ is small, it is difficult to ensure weather resistance, and an average thermal expansion coefficient becomes too large, which may cause thermal cracking of the glass plate. On the other hand, in the case where the content of SiO₂ is too large, a viscosity at the time of melting a glass increases, which may make it difficult to produce the glass.

The content of SiO₂ in the glass plate of the present embodiment is preferably 55% or more, more preferably 58% or more, still more preferably 59% or more, and particularly preferably 60% or more.

In addition, the content of SiO₂ in the glass plate of the present embodiment is preferably 70% or less, more preferably 68% or less, still more preferably 66% or less, and particularly preferably 65% or less.

Al₂O₃ is an essential component of the glass plate of the present embodiment. A content of Al₂O₃ is 5.0% or more and 10% or less. In the case where the content of Al₂O₃ is small, it is difficult to ensure the weather resistance, and the average thermal expansion coefficient becomes too large, which may cause the thermal cracking of the glass plate.

On the other hand, in the case where the content of Al₂O₃ is too large, the viscosity at the time of melting the glass increases, which may make it difficult to produce the glass. In the case where Al₂O₃ is contained, the content ofAl₂O₃ is preferably 5.5% or more, more preferably 6.0% or more, and still more preferably 6.5% or more in order to prevent phase separation of the glass and improve the weather resistance.

The content of Al₂O₃ is preferably 9.0% or less, more preferably 8.0% or less, and still more preferably 7.5% or less from viewpoints of maintaining T₂ at a low level and making it easy to produce the glass, and from a viewpoint of increasing a radio wave (millimeter wave) transmittance.

B₂O₃ is an essential component of the glass plate of the present embodiment. A content of B₂O₃ is more than 5.0% and 15% or less. B₂O₃ is contained in order to increase a glass strength and radio wave (millimeter wave) transmissibility, and also contributes to improvement of a melting property.

The content of B₂O₃ in the glass plate of the present embodiment is preferably 7.0% or more, more preferably 8.0% or more, and still more preferably 9.0% or more.

In addition, in the case where the content of B₂O₃ is too large, an alkali element is likely to volatilize during melting and forming, which may lead to a decrease in glass quality and a decrease in acid resistance and alkali resistance. Therefore, the content of B₂O₃ is preferably 14% or less, more preferably 13% or less, still more preferably 12% or less, and particularly preferably 11% or less.

In order to increase the radio wave (millimeter wave) transmittance, SiO₂ + Al₂O₃ + B₂O₃ in the glass plate of the present embodiment, that is, a total of the content of SiO₂, the content of Al₂O₃, and the content of B₂O₃ is preferably 70% or more and 85% or less.

Further, considering maintaining temperatures T₂ and T₄ of the glass plate of the present embodiment at a low level and making it easy to produce the glass, SiO₂ + Al₂O₃ + B₂O₃ is preferably 83% or less, and more preferably 82% or less.

However, in the case where the content of SiO₂ + Al₂O₃ + B₂O₃ is too small, the weather resistance may be deteriorated, and a relative dielectric constant (εᵣ) and a dielectric loss tangent (tan δ) may become too large. Therefore, SiO₂ + Al₂O₃ + B₂O₃ in the glass plate of the present embodiment is preferably 75% or more, and more preferably 76% or more.

P₂O₅ is an optional component of the glass plate of the present embodiment. A content of P₂O₅ is 0.0% or more and 10% or less. P₂O₅ has a function of decreasing a glass viscosity. In the case where P₂O₅ is contained in the glass plate of the present embodiment, the content thereof is preferably 0.2% or more, more preferably 0.5% or more, still more preferably 0.8% or more, and particularly preferably 1.0% or more.

On the other hand, P₂O₅ tends to cause defects in the glass in a float bath in the production of the glass plate of the present embodiment with a float method. Therefore, the content of P₂O₅ in the glass plate of the present embodiment is preferably 5.0% or less, more preferably 4.0% or less, still more preferably 3.0% or less, and particularly preferably 2.0% or less.

MgO is an optional component of the glass plate of the present embodiment. A content of MgO is 0.0% or more and 10% or less. MgO is a component that promotes melting of a glass raw material and improves the weather resistance and the Young’s modulus.

In the case where MgO is contained, the content thereof is preferably 2.0% or more, more preferably 2.5% or more, still more preferably 3.0% or more, particularly preferably 3.5% or more, and most preferably 4.0% or more.

In addition, in the case where the content of MgO is 10% or less, devitrification is less likely to occur, and an increase in the relative dielectric constant (εᵣ) and the dielectric loss tangent (tan δ) can be prevented. The content of MgO is preferably 7.0% or less, more preferably 6.5% or less, still more preferably 6.0% or less, particularly preferably 5.5% or less, and most preferably 5.0% or less.

CaO is an optional component of the glass plate of the present embodiment, and may be contained in a certain amount for improving the melting property of the glass raw material. A content of CaO is 0.0% or more and 10% or less. In the case where CaO is contained, the content thereof is preferably 2.0% or more, more preferably 2.5% or more, still more preferably 3.0% or more, particularly preferably 3.5% or more, and most preferably 4.0% or more. Accordingly, the melting property and formability (decrease in the T₂ and decrease in the T₄) of the glass raw material are improved.

In addition, by setting the content of CaO to 10% or less, an increase in a density of the glass is prevented, and a low brittleness and the strength are maintained. In order to prevent the glass from becoming brittle and to prevent the increase in the relative dielectric constant (εᵣ) and the dielectric loss tangent (tan δ) of the glass, the content of CaO is preferably 7.0% or less, more preferably 6.5% or less, still more preferably 6.0% or less, particularly preferably 5.5% or less, and most preferably 5.0% or less.

SrO is an optional component of the glass plate of the present embodiment, and may be contained in a certain amount for improving the melting property of the glass raw material. A content of SrO is 0.0% or more and 10% or less. In the case where SrO is contained, the content thereof is preferably 2.0% or more, more preferably 2.5% or more, still more preferably 3.0% or more, particularly preferably 3.5% or more, and most preferably 4.0% or more. Accordingly, the melting property and formability (decrease in the T₂ and decrease in the T₄) of the glass raw material are improved.

In addition, by setting the content of SrO to 10% or less, the increase in the density of the glass is prevented, and the low brittleness and the strength are maintained. In order to prevent the glass from becoming brittle and to prevent the increase in the relative dielectric constant (εᵣ) and the dielectric loss tangent (tan δ) of the glass, the content of SrO is preferably 7.0% or less. In addition, the content of SrO is more preferably 6.5% or less, still more preferably 6.0% or less, particularly preferably 5.5% or less, and most preferably 5.0% or less.

BaO is an optional component of the glass plate of the present embodiment, and may be contained in a certain amount for improving the melting property of the glass raw material. A content of BaO is 0.0% or more and 10% or less. In the case where BaO is contained, the content thereof is preferably 2.0% or more, more preferably 2.5% or more, still more preferably 3.0% or more, particularly preferably 3.5% or more, and most preferably 4.0% or more. Accordingly, the melting property and formability (decrease in the T₂ and decrease in the T₄) of the glass raw material are improved.

In addition, by setting the content of BaO to 10% or less, the increase in the density of the glass is prevented, and the low brittleness and the strength are maintained. In order to prevent the glass from becoming brittle and to prevent the increase in the relative dielectric constant (εᵣ) and the dielectric loss tangent (tan δ) of the glass, the content of BaO is preferably 7.0% or less. In addition, the content of BaO is more preferably 6.5% or less, still more preferably 6.0% or less, and particularly preferably 5.5% or less, and it is most preferable that the glass plate is substantially free of BaO.

ZnO is an optional component of the glass plate of the present embodiment, and may be contained in a certain amount for decreasing the glass viscosity. A content of ZnO is 0.0% or more and 5.0% or less. In the case where ZnO is contained, the content thereof is preferably 0.10% or more, more preferably 0.50% or more, and still more preferably 1.0% or more.

In addition, by setting the content of ZnO to 5.0% or less, the increase in the relative dielectric constant (εᵣ) and the dielectric loss tangent (tan δ) can be prevented. In order to prevent the increase in the relative dielectric constant (εᵣ) and the dielectric loss tangent (tan δ), the content of ZnO is preferably 3.0% or less. In addition, the content of ZnO is more preferably 2.5% or less, and still more preferably 2.0% or less.

Li₂O is an optional component of the glass plate of the present embodiment. A content of Li₂O is 0.0% or more and 5.0% or less. Li₂O is a component that improves the melting property of the glass, and a component that makes it easy to increase the Young’s modulus and also contributes to the increase in the glass strength.

By containing Li₂O, the glass viscosity is decreased, and thus formability of a window glass for vehicle, particularly a windshield or the like, is improved. In the case where Li₂O is contained in the glass plate of the present embodiment, the content thereof is preferably 0.10% or more, more preferably 0.40% or more, still more preferably 0.60% or more, particularly preferably 0.80% or more, and most preferably 1.0% or more.

On the other hand, in the case where the content of Li₂O is too large, the devitrification or the phase separation may occur during the production of the glass, which may make the production difficult. In addition, a large content of Li₂O may cause an increase in raw material cost and the increase in the relative dielectric constant (εᵣ) and the dielectric loss tangent (tan δ). Therefore, the content of Li₂O is preferably 4.0% or less, more preferably 3.5% or less, still more preferably 3.0% or less, particularly preferably 2.5% or less, and most preferably 2.0% or less.

Na₂O is an optional component of the glass plate of the present embodiment. A content of Na₂O is 0.0% or more and 5.0% or less. By containing Na₂O, the glass viscosity is decreased, and thus the formability of a window glass for vehicle, particularly a windshield, is improved.

In the case where Na₂O is contained, the content thereof is preferably 0.10% or more, more preferably 0.40% or more, still more preferably 0.60% or more, particularly preferably 0.80% or more, and most preferably 1.0% or more.

On the other hand, an excessively large content of Na₂O causes the increase in the relative dielectric constant (εᵣ) and the dielectric loss tangent (tan δ). Therefore, the content of Na₂O is preferably 4.0% or less, more preferably 3.5% or less, still more preferably 3.0% or less, particularly preferably 2.5% or less, and most preferably 2.0% or less.

K₂O is an optional component of the glass plate of the present embodiment. A content of K₂O is 0.0% or more and 5.0% or less. By containing K₂O, the glass viscosity is decreased, and thus the formability of a window glass for vehicle, particularly a windshield, is improved. In the case where K₂O is contained, the content thereof is preferably 0.10% or more, more preferably 0.40% or more, still more preferably 0.60% or more, particularly preferably 0.80% or more, and most preferably 1.0% or more.

On the other hand, an excessively large content of K₂O causes the increase in the relative dielectric constant (εᵣ) and the dielectric loss tangent (tan δ). Therefore, the content of K₂O is preferably 4.0% or less, more preferably 3.5% or less, still more preferably 3.0% or less, particularly preferably 2.5% or less, and most preferably 2.0% or less.

R₂O means a total content of Li₂O, Na₂O, and K₂O. A content of R₂O is 0.0% or more and 5.0% or less. In the case where R₂O in the glass plate of the present embodiment is 5.0% or less, the formability of a window glass for vehicle, particularly a windshield, is improved while maintaining the weather resistance and the radio wave (millimeter wave) transmissibility. R₂O in the glass plate of the present embodiment is preferably 4.0% or less, more preferably 3.0% or less, still more preferably 2.0% or less, particularly preferably 1.5% or less, and most preferably 1.0% or less.

In addition, from a viewpoint of lowering the temperatures T₂ and T₄ during the production, or in order to facilitate heating by direct energization to a glass melt, it is preferable to contain a small amount of R₂O. R₂O in the glass plate of the present embodiment is preferably 0.10% or more, more preferably 0.40% or more, still more preferably 0.60% or more, and particularly preferably 0.80% or more.

Fe₂O₃ is an essential component of the glass plate of the present embodiment, and is contained for providing a heat insulation property. A content of Fe₂O₃ is 0.04% or more. The content of Fe₂O₃ herein refers to a total amount of iron including FeO which is an oxide of divalent iron and Fe₂O₃ which is an oxide of trivalent iron.

In the case where the content of Fe₂O₃ is less than 0.04%, the glass plate may not be able to be used for applications requiring a heat insulation property, and it may be necessary to use an expensive raw material having a low iron content for production of the glass plate. Further, in the case where the content of Fe₂O₃ is less than 0.04%, heat radiation may reach a bottom surface of a melting furnace more than necessary at the time of melting the glass, and a load may be applied to the melting furnace.

The content of Fe₂O₃ in the glass plate of the present embodiment is preferably 0.10% or more, more preferably 0.13% or more, still more preferably 0.15% or more, and particularly preferably 0.17% or more.

On the other hand, in the case where the content of Fe₂O₃ is too large, heat transfer by radiation may be hindered and the raw material may be difficult to melt during the production. Further, in the case where the content of Fe₂O₃ is too large, a light transmittance in a visible region may be decreased, making the glass plate unsuitable for the window glass for vehicle and the like. The content of Fe₂O₃ is preferably 0.50% or less, more preferably 0.40% or less, still more preferably 0.30% or less, and particularly preferably 0.25% or less.

In addition, iron ions contained in the above Fe₂O₃ preferably satisfy 0.50 ≤ [Fe²⁺]/([Fe²⁺] + [Fe³⁺]) ≤ 0.90 on a mass basis. Accordingly, a transmittance in the visible region and a transmittance in a near-infrared region suitable for a glass for vehicle can be achieved.

Here, the terms “[Fe²⁺]” and “[Fe³⁺]” respectively mean contents of Fe²⁺ and Fe³⁺ contained in the glass plate of the present embodiment. In addition, the term “[Fe²⁺]/([Fe²⁺] + [Fe³⁺])” means a ratio of the content of Fe²⁺ to a total content of Fe²⁺ and Fe³⁺ in the glass plate of the present embodiment.

[Fe²⁺]/([Fe²⁺] + [Fe³⁺]) is determined by the following method.

After decomposing a crushed glass with a mixed acid of hydrofluoric acid and hydrochloric acid at room temperature, a certain amount of a degradation solution is dispensed into a plastic container, and a hydroxylammonium chloride solution is added to reduce Fe³⁺ in a sample solution to Fe²⁺. Thereafter, a 2,2′-dipyridyl solution and an ammonium acetate buffer solution are added to develop a color of Fe²⁺. A color development solution is adjusted to a constant amount with ion-exchanged water, and an absorbance at a wavelength of 522 nm is measured with an absorptiometer. Then, a concentration is calculated based on a calibration curve prepared by using a standard solution to determine an amount of Fe²⁺. Since Fe³⁺ in the sample solution is reduced to Fe²⁺, the amount of Fe²⁺ means “[Fe²⁺] + [Fe³⁺]” in the sample.

Next, after decomposing the crushed glass with the mixed acid of hydrofluoric acid and hydrochloric acid at room temperature, a certain amount of the degradation solution is dispensed into a plastic container, and a 2,2′-dipyridyl solution and an ammonium acetate buffer solution are quickly added to develop a color of Fe²⁺ alone. A color development solution is adjusted to a constant amount with ion-exchanged water, and an absorbance at a wavelength of 522 nm is measured with an absorptiometer. Then, a concentration is calculated based on the calibration curve prepared by using the standard solution to calculate an amount of Fe²⁺. The amount of Fe²⁺ means [Fe²⁺] in the sample.

Then, [Fe²⁺]/([Fe²⁺] + [Fe³⁺]) is calculated based on the determined [Fe²⁺] and [Fe²⁺] + [Fe³⁺].

RO represents a total content of MgO, CaO, SrO, and BaO. A content of RO is 15% or more and 30% or less. In the case where the content of RO in the glass plate of the present embodiment is 30% or less, the increase in the relative dielectric constant (εᵣ) and the dielectric loss tangent (tan δ) can be prevented while maintaining the weather resistance. The content of RO in the glass plate of the present embodiment is preferably 25% or less, more preferably 24% or less, still more preferably 23% or less, even still more preferably 22% or less, particularly preferably 21% or less, and most preferably 20% or less.

In addition, from the viewpoint of lowering the temperatures T₂ and T₄ during the production, or from a viewpoint of improving the formability of a window glass for vehicle, particularly a windshield, the content of RO in the glass plate of the present embodiment is preferably 16% or more, more preferably 17% or more, and particularly preferably 18% or more.

In the glass plate of the present embodiment, a value (B₂O₃ - Al₂O₃) obtained by subtracting the content of Al₂O₃ from the content of B₂O₃ is larger than 0.0%. That is, B₂O₃ -Al₂O₃ > 0.0%. Accordingly, it is possible to perform bending forming at a low temperature as described later. B₂O₃ - Al₂O₃ is preferably 1.0% or more, more preferably 2.0% or more, and still more preferably 3.0% or more.

In the glass plate of the present embodiment, a value (Al₂O₃/RO) obtained by dividing the content of Al₂O₃ by the content of RO is larger than 0.30 and smaller than 0.50. That is, 0.30 < Al₂O₃/RO < 0.50. Accordingly, it is possible to prevent the phase separation of the glass, prevent the glass from becoming cloudy, and decrease the glass viscosity.

In the glass plate of the present embodiment, Al₂O₃/RO is preferably 0.32 or more, more preferably 0.35 or more, and still more preferably 0.37 or more. In addition, Al₂O₃/RO is preferably 0.45 or less, more preferably 0.43 or less, and still more preferably 0.41 or less.

In the glass plate of the present embodiment, the temperature T₁₂ at which the glass viscosity is 10¹² dPa·s is 730° C. or lower. In the case where the T₁₂ is 730° C. or lower, it is possible to perform the bending forming at a low temperature. Examples of a method of setting the T₁₂ to 730° C. or lower include a method of setting the content of Al₂O₃ to 10% or less, B₂O₃ - Al₂O₃ > 0.0%, and RO ≥ 15%.

In the glass plate of the present embodiment, the T₁₂ is preferably 720° C. or lower, more preferably 715° C. or lower, still more preferably 710° C. or lower, particularly preferably 705° C. or lower, and most preferably 700° C. or lower.

In addition, from a viewpoint of a firing temperature of a black ceramic printed on a windshield, the T₁₂ is preferably 590° C. or higher, more preferably 600° C. or higher, still more preferably 610° C. or higher, and particularly preferably 620° C. or higher.

The average thermal expansion coefficient of the glass plate of the present embodiment at 50° C. to 350° C. is 40 × 10⁻⁷/K or more. In the case where the average thermal expansion coefficient of the glass plate of the present embodiment is 40 × 10⁻⁷/K or more, bending workability at a low temperature is good. The average thermal expansion coefficient can be achieved by setting the content of Al₂O₃ to 10% or less, B₂O₃ - Al₂O₃ > 0.0%, and RO ≥ 15%.

The average thermal expansion coefficient of the glass plate of the present embodiment at 50° C. to 350° C. is preferably 45 × 10⁻⁷/K or more, more preferably 47 × 10⁻⁷/K or more, and still more preferably 50 × 10⁻⁷/K or more.

On the other hand, in the glass plate of the present embodiment, in the case where the average thermal expansion coefficient is too large, thermal stress due to temperature distribution of the glass plate may be likely to occur in a forming process of the glass plate, a slow cooling process, or a forming process of a windshield, and the thermal cracking of the glass plate may occur.

In addition, in the glass plate of the present embodiment, in the case where the average thermal expansion coefficient is too large, a difference in expansion between the glass plate and a support member or the like becomes large, which may cause distortion, and the glass plate may be broken.

Therefore, the average thermal expansion coefficient of the glass plate of the present embodiment at 50° C. to 350° C. may be 70 × 10⁻⁷/K or less, preferably 68 × 10⁻⁷/K or less, more preferably 65 × 10⁻⁷/K or less, and still more preferably 60 × 10⁻⁷/K or less.

In the glass plate of the present embodiment, in the case where moisture is present in the glass, light in the near-infrared region is absorbed. Therefore, the glass plate of the present embodiment preferably contains a certain amount of moisture in order to improve the heat insulation property.

The moisture in the glass can be generally expressed by a value called a β—OH value, and the β—OH value is preferably 0.050 mm⁻¹ or more, more preferably 0.10 mm⁻¹ or more, and still more preferably 0.15 mm⁻¹ or more.

β—OH is obtained by the following equation based on a transmittance of the glass measured using a Fourier transform infrared spectrophotometer (FT-IR).

$$\text{β} \text{-OH} = \left(\text{1} / \text{X}\right) {log}_{10} \left({\text{T}}_{\text{A}} / {\text{T}}_{\text{B}}\right) \left[{\text{mm}}^{- 1}\right]$$

X: sample thickness [mm]
T_{A}: transmittance [%] at a reference wave number of 4000 cm⁻¹
T_{B}: minimum transmittance [%] near a hydroxy group absorption wave number of 3600 cm⁻¹

On the other hand, in the case where an amount of moisture in the glass is too large, inconvenience may occur in using an infrared irradiation device (laser radar or the like) in addition to transmission and reception of a millimeter radio wave. Therefore, the β—OH value of the glass plate of the present embodiment is preferably 0.70 mm⁻¹ or less, more preferably 0.60 mm⁻¹ or less, still more preferably 0.50 mm⁻¹ or less, and particularly preferably 0.40 mm⁻ ¹ or less.

A density of the glass plate of the present embodiment may be 2.4 g/cm³ or more and 2.9 g/cm³ or less. A Young’s modulus of the glass plate of the present embodiment may be 60 GPa or more and 85 GPa or less. In the case where the glass plate of the present embodiment satisfies these conditions, the glass plate can be suitably used as a window glass for building, a window glass for vehicle, or the like.

The glass plate of the present embodiment preferably contains a certain amount or more of SiO₂ in order to ensure the weather resistance, and as a result, the density of the glass plate of the present embodiment may be 2.4 g/cm³ or more.

The density of the glass plate of the present embodiment is preferably 2.5 g/cm³ or more. In the case where the density is 2.5 g/cm³ or more, a sound insulating property in a room and a vehicle is improved. In addition, in the case where the density of the glass plate of the present embodiment is 2.9 g/cm³ or less, the glass plate is less likely to become brittle, and a high sound insulating property can be maintained. The density of the glass plate of the present embodiment is preferably 2.8 g/cm³ or less.

The glass plate of the present embodiment has a high rigidity as the Young’s modulus increases, and becomes more suitable for a window glass for vehicle or the like. The Young’s modulus of the glass plate of the present embodiment is preferably 70 GPa or more, more preferably 74 GPa or more, and still more preferably 76 GPa or more.

On the other hand, in the case where Al₂O₃ or MgO is increased in order to increase the Young’s modulus, the relative dielectric constant (εᵣ) and the dielectric loss tangent (tan δ) of the glass increase, and therefore, an appropriate Young’s modulus of the glass plate of the present embodiment is 84 GPa or less, more preferably 82 GPa or less, and still more preferably 80 GPa or less.

In the glass plate of the present embodiment, the T₂ is preferably 1700° C. or lower. In the glass plate of the present embodiment, the T₄ is preferably 1300° C. or lower, and T₄ - T_{L} is preferably -50° C. or higher.

In the present description, the T₂ represents a temperature at which the glass viscosity is 10² dPa·s, the T₄ represents a temperature at which the glass viscosity is 10⁴ dPa·s, and the T_{L} represents a liquidus temperature of the glass.

In the case where the T₂ or the T₄ of the glass plate of the present embodiment is higher than the corresponding predetermined temperature, it is difficult to produce a large glass plate with a float method, a roll-out method, a down draw method, or the like.

In the glass plate of the present embodiment, the T₂ is preferably 1640° C. or lower, more preferably 1600° C. or lower, and still more preferably 1550° C. or lower. In the glass plate of the present embodiment, the T₄ is more preferably 1270° C. or lower, still more preferably 1250° C. or lower, and particularly preferably 1200° C. or lower.

The lower limit of each of the T₂ and the T₄ of the glass plate of the present embodiment is not particularly limited, and in order to maintain the weather resistance and the density of the glass, the T₂ is typically 1300° C. or higher, and the T₄ is typically 900° C. or higher. The T₂ of the glass plate of the present embodiment is preferably 1350° C. or higher, and more preferably 1400° C. or higher. The T₄ of the glass plate of the present embodiment is preferably 1000° C. or higher, and more preferably 1050° C. or higher.

Further, in order to enable production with a float method, T₄ - T_{L} of the glass plate of the present embodiment is preferably -50° C. or higher. In the case where this difference is less than -50° C., the devitrification occurs in the glass during glass forming, resulting in problems such as deterioration of mechanical properties of the glass and deterioration of transparency, and a high-quality glass may not be obtained. T₄ - T_{L} of the glass plate of the present embodiment is more preferably 0° C. or higher, and still more preferably +20° C. or higher.

In the glass plate of the present embodiment, T_{g} is preferably 550° C. or higher and 700° C. or lower. In the present description, the T_{g} represents a glass transition point of the glass. In the case where the T_{g} is within this predetermined temperature range, the glass can be bent within a normal producing condition range.

In the case where the T_{g} of the glass plate of the present embodiment is lower than 550° C., there is no problem in the formability, but an alkali content or an alkaline earth content becomes too large, and problems that the radio wave (millimeter wave) transmissibility is decreased, thermal expansion of the glass is excessive, and the weather resistance is decreased, and the like are likely to occur. In addition, in the case where the T_{g} of the glass plate of the present embodiment is lower than 550° C., the glass may devitrify and may not be formed in a forming temperature range.

The T_{g} of the glass plate of the present embodiment is more preferably 570° C. or higher, still more preferably 580° C. or higher, and particularly preferably 600° C. or higher. On the other hand, in the case where the T_{g} is too high, a high temperature is required at the time of bending the glass, which makes the production difficult. The T_{g} of the glass plate of the present embodiment is more preferably 670° C. or lower, still more preferably 660° C. or lower, and particularly preferably 650° C. or lower.

In the glass plate of the present embodiment, a low dielectric loss tangent (tan δ) can be obtained by adjusting compositions, and as a result, a dielectric loss can be reduced, and a high radio wave (millimeter wave) transmittance can be achieved. In the glass plate of the present embodiment, the relative dielectric constant (εᵣ) can also be adjusted by adjusting the compositions in the same manner, reflection of a radio wave at an interface with an interlayer can be prevented, and the high radio wave (millimeter wave) transmittance can be achieved.

The relative dielectric constant (εᵣ) of the glass plate of the present embodiment at a frequency of 10 GHz is preferably 6.5 or less. In the case where the relative dielectric constant (εᵣ) at the frequency of 10 GHz is 6.5 or less, a difference in the relative dielectric constant (εᵣ) from the interlayer is small, and the reflection of the radio wave at the interface with the interlayer can be prevented.

The relative dielectric constant (εᵣ) of the glass plate of the present embodiment at the frequency of 10 GHz is more preferably 6.4 or less, still more preferably 6.3 or less, even still more preferably 6.2 or less, particularly preferably 6.1 or less, and most preferably 6.0 or less.

The lower limit of the relative dielectric constant (εᵣ) of the glass plate of the present embodiment at the frequency of 10 GHz is not particularly limited, and is, for example, 5.0 or more.

The dielectric loss tangent (tan δ) of the glass plate of the present embodiment at the frequency of 10 GHz is preferably 0.0090 or less. In the case where the dielectric loss tangent (tan δ) at the frequency of 10 GHz is 0.0090 or less, the radio wave transmittance can be increased.

The dielectric loss tangent (tan δ) of the glass plate of the present embodiment at the frequency of 10 GHz is more preferably 0.0080 or less, still more preferably 0.0070 or less, particularly preferably 0.0065 or less, and most preferably 0.0060 or less.

The lower limit of the dielectric loss tangent (tan δ) of the glass plate of the present embodiment at the frequency of 10 GHz is not particularly limited, and is, for example, 0.0030 or more.

In the case where the relative dielectric constant (εᵣ) and the dielectric loss tangent (tan δ) of the glass plate of the present embodiment at the frequency of 10 GHz satisfy the above ranges, the high radio wave (millimeter wave) transmittance can be achieved even at a frequency of 10 GHz to 90 GHz.

The relative dielectric constant (εᵣ) and the dielectric loss tangent (tan δ) of the glass plate of the present embodiment at the frequency of 10 GHz can be measured with, for example, a split post dielectric resonator method (SPDR method). For such a measurement, a nominal fundamental frequency of 10 GHz type split post dielectric resonator manufactured by QWED Company, a vector network analyzer E8361C manufactured by Keysight Technologies, 85071E option 300 dielectric constant calculation software manufactured by Keysight Technologies, or the like may be used.

In the case where the glass plate of the present embodiment contains NiO, formation of NiS may cause glass breakage, and thus a content of NiO is preferably 0.010% or less. The content of NiO in the glass plate of the present embodiment is more preferably 0.0050% or less, and it is still more preferable that the glass plate be substantially free of NiO.

The glass plate of the present embodiment may contain components (hereinafter, also referred to as “other components”) other than SiO₂, Al₂O₃, B₂O₃, P₂O₅, MgO, CaO, SrO, BaO, ZnO, Li₂O, Na₂O, K₂O, and Fe₂O₃, and in the case where the other components are contained, a total content thereof is preferably 5.0% or less. Examples of the other components include, for example, ZrO₂, Y₂O₃, Nd₂O₅, GaO₂, GeO₂, MnO₂, CoO, Cr₂O₃, V₂O₅, Se, Au₂O₃, Ag₂O, CuO, CdO, SO₃, Cl, F, SnO₂, and Sb₂O₃, and the other components may be metal ions or oxides.

The other components may be contained in an amount of 5.0% or less for various purposes (for example, refining and coloring). In the case where the content of the other components is more than 5.0%, the radio wave (millimeter wave) transmittance may be decreased. The content of the other components is preferably 2.0% or less, more preferably 1.0% or less, still more preferably 0.50% or less, particularly preferably 0.30% or less, and most preferably 0.10% or less. In order to prevent an influence on the environment, each of a content of As₂O₃ and a content of PbO is preferably less than 0.0010%.

The glass plate of the present embodiment may contain Cr₂O₃. Cr₂O₃ acts as an oxidant to control an amount of FeO. In the case where Cr₂O₃ is contained in the glass plate of the present embodiment, a content thereof is preferably 0.0020% or more, and more preferably 0.0040% or more.

On the other hand, since Cr₂O₃ has coloring in light in the visible region, a visible light transmittance may be decreased. In the case where Cr₂O₃ is contained in the glass plate of the present embodiment, the content thereof is preferably 1.0% or less, more preferably 0.50% or less, still more preferably 0.30% or less, and particularly preferably 0.10% or less.

The glass plate of the present embodiment may contain SnO₂. SnO₂ acts as a reducing agent to control the amount of FeO. In the case where SnO₂ is contained in the glass plate of the present embodiment, a content thereof is preferably 0.010% or more, more preferably 0.040% or more, still more preferably 0.060% or more, and particularly preferably 0.080% or more.

On the other hand, in order to prevent defects due to SnO₂ during the production of the glass plate, the content of SnO₂ in the glass plate of the present embodiment is preferably 1.0% or less, more preferably 0.50% or less, still more preferably 0.30% or less, and particularly preferably 0.20% or less.

The glass plate of the present embodiment preferably has a sufficient visible light transmittance, and when a thickness of the glass plate is converted into 2.00 mm, a visible light transmittance Tv defined by ISO-9050:2003 using a D65 light source is preferably 75% or more. The Tv is preferably 77% or more, and more preferably 80% or more. In addition, the Tv is, for example, 90% or less.

The glass plate of the present embodiment preferably has a high heat insulation property, and when the thickness is converted into 2.00 mm, a total solar transmittance Tts defined by ISO-13837:2008 convention A and measured at a wind speed of 4 m/s is preferably 88% or less. The Tts is preferably 80% or less, and more preferably 78% or less. In addition, the Tts is, for example, 70% or more.

The glass plate of the present embodiment preferably has a low ultraviolet transmissibility, and when the thickness is converted into 2.00 mm, an ultraviolet transmittance Tuv defined by ISO-9050:2003 is preferably 50% or less. The Tuv is more preferably 40% or less, and still more preferably 20% or less. In addition, the Tuv is, for example, 10% or more.

In the glass plate of the present embodiment, when the thickness is converted into 2.00 mm, a* defined by JIS Z 8781-4 using a D65 light source is preferably -5.0 or more, more preferably -3.0 or more, and still more preferably -2.0 or more. In addition, the a* is preferably 2.0 or less, more preferably 1.0 or less, and still more preferably 0 or less.

Further, when the thickness is converted into 2.00 mm, b* defined by JIS Z 8781-4 using a D65 light source is preferably -5.0 or more, more preferably -3.0 or more, and still more preferably -1.0 or more. In addition, the b* is preferably 5.0 or less, more preferably 4.0 or less, and still more preferably 3.0 or less. In the case where the a* and the b* are within the above ranges, the glass plate of the present embodiment is excellent in design as the window glass for building and the window glass for vehicle.

A method for producing the glass plate of the present embodiment is not particularly limited, and for example, a glass plate formed with a known float method is preferred. In the float method, a molten glass base material is floated on a molten metal such as tin, and a glass plate having a uniform thickness and width is formed under strict temperature control.

Alternatively, a glass plate formed with a known roll-out method or down draw method may be used, or a glass plate having a polished surface and a uniform thickness may be used.

Here, the down draw method is roughly classified into a slot down draw method and an overflow down draw method (fusion method), and both of the methods are methods in which a molten glass is continuously poured down from a formed body to form a glass ribbon in a band plate shape.

The glass plate of the present embodiment may be subjected to thermal strengthening. A thermal strengthened glass is obtained by subjecting the glass plate to a heat strengthening treatment. In the heat strengthening treatment, the uniformly heated glass plate is rapidly cooled from a temperature near a softening point, and a compressive stress is generated on a surface of the glass due to a temperature difference between the surface of the glass and an inside of the glass. The compressive stress is generated uniformly over the entire surface of the glass, and a compressive stress layer having a uniform depth is formed over the entire surface of the glass. The heat strengthening treatment is more suitable for strengthening a thick glass plate than a chemical strengthening treatment.

Normally, a glass having a low alkali content or containing no alkali has a small average thermal expansion coefficient, and thus there is a problem that it is difficult to apply the thermal strengthening. However, the glass plate of the present embodiment has an average thermal expansion coefficient larger than that of a related-art glass having a low alkali content or containing no alkali, and thus can be subjected to the thermal strengthening.

### Laminated Glass

A laminated glass according to an embodiment of the present invention includes: a first glass plate; a second glass plate; and an interlayer sandwiched between the first glass plate and the second glass plate. At least one of the first glass plate and the second glass plate is the above glass plate.

FIG. 1 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12.

The laminated glass 10 according to the present embodiment is not limited to an aspect of FIG. 1, and can be modified without departing from the gist of the present invention. For example, the interlayer 13 may be formed as one layer as illustrated in FIG. 1, or may be formed as two or more layers. The laminated glass 10 according to the present embodiment may include three or more glass plates, and in this case, an organic resin or the like may be interposed between adjacent glass plates. Hereinafter, the laminated glass 10 according to the present embodiment will be described in a configuration in which only two glass plates, that is, the first glass plate 11 and the second glass plate 12 are included, and the interlayer 13 is sandwiched therebetween.

In the laminated glass of the present embodiment, it is preferable to use the above glass plate for both the first glass plate 11 and the second glass plate 12 from viewpoints of radio wave transmissibility and bending workability. In this case, the first glass plate 11 and the second glass plate 12 may be glass plates having the same composition or glass plates having different compositions.

In the case where one of the first glass plate 11 and the second glass plate 12 is not the above glass plate, a type of the glass plate is not particularly limited, and a known glass plate in the related art used for a window glass for vehicle or the like may be used. Specific examples thereof include an alkali aluminosilicate glass and a soda lime glass. These glass plates may be colored to such an extent that transparency thereof is not impaired, or may not be colored.

In the laminated glass of the present embodiment, one of the first glass plate 11 and the second glass plate 12 may be an alkali aluminosilicate glass containing 1.0% or more of Al₂O₃. By using the above alkali aluminosilicate glass as the first glass plate 11 or the second glass plate 12, chemical strengthening can be performed as described later, and a strength can be increased.

From viewpoints of weather resistance and the chemical strengthening, a content of Al₂O₃ in the above alkali aluminosilicate glass is more preferably 2.0% or more, and still more preferably 2.5% or more. In addition, in the alkali aluminosilicate glass, in the case where the content of Al₂O₃ is large, a radio wave (millimeter wave) transmittance may be decreased, and thus the content of Al₂O₃ is preferably 20% or less, and more preferably 15% or less.

From the viewpoint of the chemical strengthening, a content of R₂O in the above alkali aluminosilicate glass is preferably 10% or more, more preferably 12% or more, and still more preferably 13% or more.

In addition, in the alkali aluminosilicate glass, in the case where the content of R₂O is large, the radio wave (millimeter wave) transmittance may be decreased, and thus the content of R₂O is preferably 25% or less, more preferably 20% or less, and still more preferably 19% or less. Here, R₂O represents Li₂O, Na₂O, or K₂O.

Specific examples of the above alkali aluminosilicate glass include a glass having the following composition. Each component is expressed in terms of molar percentage based on oxides.
61% ≤ SiO₂ ≤ 77%
1.0% ≤ Al₂O₃ ≤ 20%
0.0% ≤ B₂O₃ ≤ 10%
0.0% ≤ MgO ≤ 15%
0.0% ≤ CaO ≤ 10%
0.0% ≤ SrO ≤ 1.0%
0.0% ≤ BaO ≤ 1.0%
0.0% ≤ Li₂O ≤ 15%
2.0% ≤ Na₂O ≤ 15%
0.0% ≤ K₂O ≤ 6.0%
0.0% ≤ ZrO₂ ≤ 4.0%
0.0% ≤ TiO₂ ≤ 1.0%
0.0% ≤ Y₂O₃ ≤ 2.0%
10% ≤ R₂O ≤ 25%
0.0% ≤ RO ≤ 20%
(R₂O represents a total amount of Li₂O, Na₂O, and K₂O, and RO represents a total amount of MgO, CaO, SrO, and BaO.)

In the laminated glass of the present embodiment, one of the first glass plate 11 and the second glass plate 12 may be a soda lime glass. The soda lime glass may be a soda lime glass containing less than 1.0% of Al₂O₃. Specific examples thereof include a glass having the following composition.
60% ≤ SiO₂ ≤ 75%
0.0% ≤ Al₂O₃ <1.0%
2.0% ≤ MgO ≤ 11%
2.0% ≤ CaO ≤ 10%
0.0% ≤ SrO ≤ 3.0%
0.0% ≤ BaO ≤ 3.0%
10% ≤ Na₂O ≤ 18%
0.0% ≤ K₂O ≤ 8.0%
0.0% ≤ ZrO₂ ≤ 4.0%
0.0010% ≤ Fe₂O₃ ≤ 5.0%

The lower limit of a thickness of the first glass plate 11 or the second glass plate 12 is preferably 0.50 mm or more, more preferably 0.70 mm or more, still more preferably 1.00 mm or more, particularly preferably 1.20 mm or more, and most preferably 1.50 mm or more. The thickness of the first glass plate 11 or the second glass plate 12 is preferably 0.50 mm or more from a viewpoint of impact resistance.

In addition, the upper limit of the thickness of the first glass plate 11 or the second glass plate 12 is preferably 3.70 mm or less, more preferably 3.50 mm or less, still more preferably 3.20 mm or less, even still more preferably 3.00 mm or less, particularly preferably 2.50 mm or less, and most preferably 2.20 mm or less.

In the case where the thickness of the first glass plate 11 or the second glass plate 12 is 3.70 mm or less, a weight of the laminated glass 10 does not become too large, which is preferred from a viewpoint of improving fuel efficiency in a case of using for a vehicle.

The first glass plate 11 and the second glass plate 12 may have the same thickness or may have different thicknesses.

In the laminated glass 10 of the present embodiment, a total thickness of the first glass plate 11, the second glass plate 12, and the interlayer 13 is preferably 2.30 mm or more. In the case where the total thickness is 2.30 mm or more, a sufficient strength is obtained. The total thickness is more preferably 2.50 mm or more, still more preferably 2.70 mm or more, even still more preferably 3.00 mm or more, particularly preferably 3.50 mm or more, and most preferably 4.00 mm or more.

In addition, from viewpoints of improving the radio wave transmissibility and reducing a weight, the total thickness may be 5.00 mm or less, preferably 4.90 mm or less, more preferably 4.85 mm or less, and still more preferably 4.80 mm or less.

In the laminated glass 10 of the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 is gradually decreased.

One of the first glass plate 11 and the second glass plate 12 may be a chemically strengthened glass subjected to glass strengthening in order to increase a strength. Examples of a method of a chemical strengthening treatment include an ion exchange method. In the ion exchange method, a glass plate is immersed in a treatment liquid (for example, potassium nitrate molten salt), and ions having a small ion radius (for example, Na ions) contained in the glass are exchanged for ions having a large ion radius (for example, K ions), thereby generating a compressive stress on a surface of the glass. The compressive stress is generated uniformly over the entire surface of the glass plate, and a compressive stress layer having a uniform depth is formed over the entire surface of the glass plate.

Each of a magnitude of the compressive stress on the surface of the glass plate (hereinafter, also referred to as a surface compressive stress CS) and a depth DOL of the compressive stress layer formed on the surface of the glass plate can be adjusted by a glass composition, a chemical strengthening treatment time, and a chemical strengthening treatment temperature. Examples of the chemically strengthened glass include a glass obtained by performing a chemical strengthening treatment on the above alkali aluminosilicate glass.

The first glass plate 11 and the second glass plate 12 may have a flat plate shape, or may have a curved shape having a curvature on the entire surface or a part thereof.

In the case where the first glass plate 11 and the second glass plate 12 are curved, the first glass plate 11 and the second glass plate 12 may have a single-curved shape curved only in one of a vertical direction and a horizontal direction, or may have a multiple-curved shape curved in both the vertical direction and the horizontal direction.

In the case where the first glass plate 11 and the second glass plate 12 have the multiple-curved shape, a radius of curvature thereof may be the same or different in the vertical direction and the horizontal direction.

In the case where the first glass plate 11 and the second glass plate 12 are curved, the radius of curvature in the vertical direction and/or the horizontal direction is preferably 1000 mm or more.

A shape of a main surface of the first glass plate 11 and the second glass plate 12 is, for example, in a case of the window glass for vehicle, a shape that fits a window opening of a vehicle on which the first glass plate 11 and the second glass plate 12 are to be mounted.

The interlayer 13 according to the present embodiment is sandwiched between the first glass plate 11 and the second glass plate 12. Since the laminated glass 10 of the present embodiment includes the interlayer 13, the first glass plate 11 and the second glass plate 12 can be firmly adhered to each other, and an impact force when scattered pieces collide with the glass plate can be reduced.

As the interlayer 13, various organic resins generally used for a laminated glass used as a laminated glass for a vehicle in the related art may be used. For example, polyethylene (PE), ethylene vinyl acetate copolymer (EVA), polypropylene (PP), polystyrene (PS), methacrylic resin (PMA), polyvinyl chloride (PVC), polyethylene terephthalate (PET), polybutylene terephthalate (PBT), cellulose acetate (CA), diallyl phthalate resin (DAP), urea resin (UP), melamine resin (MF), unsaturated polyester (UP), polyvinyl butyral (PVB), polyvinyl formal (PVF), polyvinyl alcohol (PVAL), vinyl acetate resin (PVAc), ionomer (IO), polymethylpentene (TPX), vinylidene chloride (PVDC), polysulfone (PSF), polyvinylidene fluoride (PVDF), methacrylate-styrene copolymer resin (MS), polyarylate (PAR), polyarylsulfone (PASF), polybutadiene (BR), polyethersulfone (PESF), polyether ether ketone (PEEK), or the like may be used. Among these, EVA and PVB are suitable from viewpoints of transparency and adhesion, and PVB is particularly preferred because PVB can provide a sound insulating property.

A thickness of the interlayer 13 is preferably 0.30 mm or more, more preferably 0.50 mm or more, and still more preferably 0.70 mm or more from viewpoints of the reduction in the impact force and the sound insulating property.

In addition, the thickness of the interlayer 13 is preferably 1.00 mm or less, more preferably 0.90 mm or less, and still more preferably 0.80 mm or less from a viewpoint of preventing a decrease in a visible light transmittance.

The thickness of the interlayer 13 is preferably in a range of 0.30 mm to 1.00 mm, and more preferably in a range of 0.70 mm to 0.80 mm.

The thickness of the interlayer 13 may be constant over the entire surface, or may be changed for each portion as necessary.

If a difference in linear expansion coefficient between the interlayer 13 and the first glass plate 11 or the second glass plate 12 is large, in the case where the laminated glass 10 is produced through a heating process to be described later, the laminated glass 10 may be cracked or warped, resulting in a poor appearance.

Accordingly, the difference in the linear expansion coefficient between the interlayer 13 and the first glass plate 11 or the second glass plate 12 is preferably as small as possible. The difference in the linear expansion coefficient between the interlayer 13 and the first glass plate 11 or the second glass plate 12 may be represented by a difference between average thermal expansion coefficients in a predetermined temperature range.

Particularly, a resin constituting the interlayer 13 has a low glass transition point, and thus a predetermined average thermal expansion coefficient difference may be set in a temperature range equal to or lower than the glass transition point of the resin material. A difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive may be used.

In the case where the interlayer 13 is the adhesive layer, it is not necessary to perform the heating process in a process of bonding the first glass plate 11 and the second glass plate 12, and thus the above cracking or warpage is less likely to occur.

### Other Layers

The laminated glass 10 of the embodiment of the present invention may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, and an infrared reflective film may be provided.

Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 of the present embodiment may include a black ceramic layer or the like which is disposed in a band shape on a part or all of a peripheral edge portion for a purpose of hiding an attachment portion to a frame body or the like, a wiring conductor, or the like.

A method for producing the laminated glass 10 of the embodiment of the present invention may be the same as that for a known laminated glass in the related art. For example, through a process of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the embodiment of the present invention, for example, after a process of heating and forming each of the first glass plate 11 and the second glass plate 12, a process of inserting the interlayer 13 between the first glass plate 11 and the second glass plate 12 and performing heating and pressing may be performed. Through such processes, the laminated glass 10 having the configuration in which the first glass plate 11 and the second glass plate 12 are bonded via the interlayer 13 may be obtained.

In the laminated glass 10 of the embodiment of the present invention, the total thickness of the first glass plate 11, the second glass plate 12, and the interlayer 13 is 5.00 mm or less, and the visible light transmittance Tv defined by ISO-9050:2003 using a D65 light source is preferably 70% or more. The Tv is more preferably 71% or more, and still more preferably 72% or more. In addition, the Tv is, for example, 90% or less.

In the laminated glass 10 according to the embodiment of the present invention, the total thickness of the first glass plate 11, the second glass plate 12, and the interlayer 13 is 5.00 mm or less, and the total solar transmittance Tts defined by ISO-13837:2008 convention A and measured at a wind speed of 4 m/s is preferably 70% or less. In the case where the total solar transmittance Tts of the laminated glass 10 according to the embodiment of the present invention is 70% or less, a sufficient heat insulation property is obtained.

The Tts is more preferably 68% or less, and still more preferably 66% or less. In addition, the Tts is, for example, 55% or more.

In the laminated glass 10 according to the embodiment of the present invention, the total thickness of the first glass plate 11, the second glass plate 12, and the interlayer 13 is 5.00 mm or less, and a maximum value of a radio wave transmission loss S21 when a radio wave having a frequency of 75 GHz to 80 GHz is incident on the first glass plate 11 at an incident angle of 60° is preferably -4.0 dB or more.

The maximum value of the radio wave transmission loss S21 under the above condition is preferably -3.0 dB or more, and more preferably -2.5 dB or more. In addition, the maximum value of the radio wave transmission loss S21 under the above condition is, for example, -0.50 dB or less.

Here, the radio wave transmission loss S21 means an insertion loss derived based on a relative dielectric constant (εᵣ) and a dielectric loss tangent (tan δ) (where δ is a loss angle) of each material used for the laminated glass, and the smaller an absolute value of the radio wave transmission loss S21 is, the higher the radio wave transmissibility is.

The incident angle means an angle of an incident direction of a radio wave from a normal line of a main surface of the laminated glass 10.

In the laminated glass 10 according to the embodiment of the present invention, the total thickness of the first glass plate 11, the second glass plate 12, and the interlayer 13 is 5.00 mm or less, and a maximum value of the radio wave transmission loss S21 when the radio wave having the frequency of 75 GHz to 80 GHz is incident on the first glass plate 11 at an incident angle of 45° is preferably -4.0 dB or more.

The maximum value of the radio wave transmission loss S21 under the above condition is preferably -3.0 dB or more, and more preferably -2.5 dB or more. In addition, the maximum value of the radio wave transmission loss S21 under the above condition is, for example, -0.50 dB or less.

In the laminated glass 10 according to the embodiment of the present invention, the total thickness of the first glass plate 11, the second glass plate 12, and the interlayer 13 is 5.00 mm or less, and a maximum value of the radio wave transmission loss S21 when the radio wave having the frequency of 75 GHz to 80 GHz is incident on the first glass plate 11 at an incident angle of 20° is preferably -4.0 dB or more.

The maximum value of the radio wave transmission loss S21 under the above condition is preferably -3.0 dB or more, and more preferably -2.5 dB or more. In addition, the maximum value of the radio wave transmission loss S21 under the above condition is, for example, -0.50 dB or less.

In the laminated glass 10 according to the embodiment of the present invention, the total thickness of the first glass plate 11, the second glass plate 12, and the interlayer 13 is 5.00 mm or less, and the chromaticity a* defined by JIS Z 8781-4 using a D65 light source is preferably -8.0 or more, more preferably -7.0 or more, and still more preferably -6.0 or more. In addition, the a* is preferably 2.0 or less, more preferably 1.0 or less, and still more preferably 0 or less.

Further, the total thickness of the first glass plate 11, the second glass plate 12, and the interlayer 13 is 5.00 mm or less, and the chromaticity b* defined by JIS Z 8781-4 using a D65 light source is preferably -5.0 or more, more preferably -3.0 or more, and still more preferably -1.0 or more.

In addition, the b* is preferably 7.0 or less, more preferably 6.0 or less, and still more preferably 5.0 or less.

In the case where the a* and the b* are within the above ranges, the glass plate of the present embodiment is excellent in design as a window glass for building and a window glass for vehicle.

### Window Glass for Building, Window Glass for Vehicle

A window glass for building and a window glass for vehicle of the present embodiment include the above glass plate. The window glass for building and the window glass for vehicle of the present embodiment may be made from the above laminated glass.

Hereinafter, an example in which the laminated glass 10 of the present embodiment is used as a window glass for vehicle will be described with reference to the drawings.

FIG. 2 is a conceptual view illustrating a state in which the laminated glass 10 of the present embodiment is mounted on an opening 110 formed at a front part of an automobile 100 and used as a window glass of the automobile. In the laminated glass 10 used as the window glass of the automobile, a housing (case) 120 in which an information device or the like is housed for ensuring traveling safety of a vehicle may be attached to a surface on an inner side of the vehicle.

The information device housed in the housing is a device that uses a camera, a radar, or the like to prevent a rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, a visible light, an infrared light, and the like.

FIG. 3 is an enlarged view of a portion S illustrated in FIG. 2, and is a perspective view illustrating a portion where the housing 120 is attached to the laminated glass 10 of the present embodiment. The housing 120 stores a millimeter wave radar 201 and a stereo camera 202 as the information device. The housing 120 in which the information device is stored is normally attached to a vehicle outer side with respect to a back mirror 150 and a vehicle inner side with respect to the laminated glass 10, and may be attached to another portion.

FIG. 4 is a cross-sectional view including a line Y-Y in FIG. 3 in a direction orthogonal to a horizontal line. The first glass plate 11 of the laminated glass 10 is disposed on the vehicle outer side. As described above, an incident angle θ of a radio wave 300 used for communication of the information device such as the millimeter wave radar 201 with respect to the main surface of the first glass plate 11 may be evaluated as, for example, 20°, 45°, or 60° as described above.

### EXAMPLES

Hereinafter, the present invention will be specifically described with reference to Examples, but the present invention is not limited thereto.

### Production of Glass Plates of Examples 1 to 42

Raw materials were charged into a platinum crucible so as to obtain each glass composition (unit: mol%) shown in Tables 1 to 4, and melted at 1650° C. for 3 hours to obtain each molten glass. Each of the molten glasses was poured onto a carbon plate and slowly cooled under a condition of 1° C./min. Both surfaces of each of the obtained plate-shaped glass were polished to obtain each glass plate having a thickness of 2.00 mm. Examples 1 to 8 are comparative examples, and Examples 9 to 42 are inventive examples. In Tables 1 to 4, in addition to the compositions, an amount of C, an amount of F, and an amount of SO₃ charged as raw materials were shown. The amount of C, the amount of F, and the amount of SO₃ represent, with respect to 100 mass% of a total glass raw material of SiO₂, Al₂O₃, B₂O₃, P₂O₅, MgO, CaO, SrO, BaO, ZnO, Li₂O, Na₂O, K₂O, ZrO₂, and Fe₂O₃, relative amounts (unit: mass%) of C, F, and SO₃ charged at the time of melting the glass raw material, respectively.

Methods for determining numerical values shown in Tables 1 to 4 are shown below.

### Glass Transition Point (T_{g})_{:}

The glass transition point is a value measured using TMA and determined according to a standard of JIS R3103-3 (2001).

### Average Thermal Expansion Coefficient at 50° C. to 350° C. (CTE (50 to 350)):

The average thermal expansion coefficient was measured using a differential thermal dilatometer (TMA) and was determined according to a standard of JIS R3102 (1995).

### Viscosity:

The viscosity was measured using a rotational viscometer, and a temperature T₂ (reference temperature of a melting property) at which a viscosity η was 10² dPa·s and a temperature T₄ (reference temperature of formability) at which the viscosity η was 10⁴ dPa·s were measured. A temperature T_{7.65} (softening point) at which the viscosity η was 10^{7.65} dPa·s was determined according to a standard of JIS R3103-1 (2001). A temperature T₁₂ (reference temperature of bending workability) at which the viscosity η was 10¹² dPa·s was measured with a beam bending method.

### Density:

About 20 g of a glass mass containing no foam and cut out from the glass plate was measured with Archimedes method.

### Young’s Modulus:

The Young’s modulus was measured at 25° C. with an ultrasonic pulse method (Olympus, DL35).

### Relative Dielectric Constant (εᵣ) and Dielectric Loss Tangent (tan Δ):

The relative dielectric constant (εᵣ) and the dielectric loss tangent (tan δ) at a frequency of 10 GHz were measured with a method (SPDR method) using a split post dielectric resonator manufactured by QWED Company.

### Visible Light Transmittance (Tv):

The Tv, when a thickness of the glass plate was converted into 2.00 mm, was measured with a method defined by ISO-9050:2003 using a D65 light source. The Tv was measured using a spectrophotometer LAMBDA 950 manufactured by Perkinelmer.

### Total Solar Transmittance (Tts):

The Tts, when a thickness of the glass plate was converted into 2.00 mm, was determined with a method defined by ISO-13837:2008 convention A and measured at a wind speed of 4 m/s. The Tts was measured using a spectrophotometer LAMBDA 950 manufactured by Perkinelmer.

### Ultraviolet Transmittance (Tuv):

The Tuv, when a thickness of the glass plate was converted into 2.00 mm, was measured with a method defined by ISO-9050:2003. The Tuv was measured using a spectrophotometer LAMBDA 950 manufactured by Perkinelmer.

### Chromaticity (a*, b*):

The chromaticities a* and b* defined by JIS Z 8781-4 were measured using a D65 light source.

Measurement results are shown in Tables 1 to 4. In Tables 1 to 4, “-” indicates that no measurement was performed.

TABLE 1

| mol% | Example 1 | Example 2 | Example 3 | Example 4 | Example 5 | Example 6 | Example 7 | Example 8 | Example 9 | Example 10 |
|---|---|---|---|---|---|---|---|---|---|---|
| SiO₂ | 69.54 | 65.96 | 69.86 | 71.86 | 69.86 | 71.52 | 68.85 | 68.86 | 66.86 | 68.85 |
| Al₂O₃ | 0.90 | 10.99 | 2.99 | 2.99 | 0.00 | 3.61 | 3.99 | 3.99 | 5.99 | 5.99 |
| B₂O₃ | 0.00 | 7.50 | 9.98 | 9.98 | 9.98 | 11.02 | 9.98 | 9.98 | 9.98 | 7.98 |
| P₂O₅ | 0.00 | 0.00 | 0.00 | 0.00 | 0.00 | 0.00 | 0.00 | 0.00 | 0.00 | 0.00 |
| MgO | 7.09 | 5.70 | 2.99 | 4.99 | 0.20 | 3.80 | 4.24 | 2.99 | 4.24 | 4.24 |
| CaO | 9.09 | 4.90 | 9.98 | 9.98 | 9.98 | 9.85 | 4.24 | 6.99 | 4.24 | 4.24 |
| SrO | 0.00 | 4.90 | 2.99 | 0.00 | 3.99 | 0.00 | 4.24 | 3.99 | 4.24 | 4.24 |
| BaO | 0.00 | 0.04 | 1.00 | 0.00 | 4.99 | 0.00 | 4.24 | 2.99 | 4.24 | 4.24 |
| ZnO | 0.00 | 0.00 | 0.00 | 0.00 | 1.00 | 0.00 | 0.00 | 0.00 | 0.00 | 0.00 |
| Li₂O | 0.00 | 0.00 | 0.00 | 0.00 | 0.00 | 0.00 | 0.00 | 0.00 | 0.00 | 0.00 |
| Na₂O | 12.59 | 0.00 | 0.00 | 0.00 | 0.00 | 0.00 | 0.00 | 0.00 | 0.00 | 0.00 |
| K₂O | 0.60 | 0.00 | 0.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 |
| Fe₂O₃ | 0.18 | 0.021 | 0.20 | 0.19 | 0.20 | 0.21 | 0.21 | 0.21 | 0.21 | 0.21 |
| In total | 100 | 100 | 100 | 100 | 100 | 100 | 100 | 100 | 100 | 100 |
| C [wt%] outer percentage | 0.00 | 0.00 | 0.00 | 0.00 | 0.00 | 0.00 | 0.00 | 0.00 | 0.00 | 0.00 |
| F [wt%] outer percentage | 0.00 | 0.16 | 0.00 | 0.00 | 0.00 | 0.00 | 0.16 | 0.16 | 0.16 | 0.16 |
| SO₃ [wt%] outer percentage | 0.20 | 0.30 | 0.32 | 0.32 | 0.32 | 0.32 | 0.32 | 0.32 | 0.32 | 0.32 |
| RO | 16.2 | 15.5 | 17.0 | 15.0 | 19.2 | 13.7 | 17.0 | 17.0 | 17.0 | 17.0 |
| R₂O | 13.2 | 0.0 | 0.0 | 0.0 | 0.0 | 0.0 | 0.0 | 0.0 | 0.0 | 0.0 |
| SiO₂ + Al₂O₃ + B₂O₃ | 70.4 | 84.4 | 82.8 | 84.8 | 79.8 | 86.2 | 82.8 | 82.8 | 82.8 | 82.8 |
| B₂O₃ - Al₂O₃ | -0.9 | -3.5 | 7.0 | 7.0 | 10.0 | 7.4 | 6.0 | 6.0 | 4.0 | 2.0 |
| Al₂O₃/RO | 0.06 | 0.71 | 0.18 | 0.20 | 0.00 | 0.26 | 0.24 | 0.24 | 0.35 | 0.35 |
| Thickness [mm] | 2.00 | 2.00 | 2.00 | 2.00 | 2.00 | 2.00 | 2.00 | 2.00 | 2.00 | 2.00 |
| T_{g} (TMA) [°C] | 549 | 710 | | | | | | | 659 | 659 |
| CTE (50 to 350) [× 10^⁻⁷/K] | 91 | 38 | - | - | - | - | - | - | 46 | 45 |
| Softening point_T_{7.65} [°C] | 724 | 950 | - | - | - | - | - | - | ≤ 900 | ≤ 900 |
| T₁₂ [°C] | 590 | 769 | - | - | - | - | - | - | 712 | 723 |
| T₂ [°C] | 1464 | 1645 | - | - | - | - | - | - | ≤ 1640 | ≤ 1640 |
| T₄ [°C] | 1041 | 1275 | - | - | - | - | - | - | ≤ 1250 | ≤ 1250 |
| Density [g/cm³] | 2.5 | 2.5 | - | - | - | - | 2.60 | 2.58 | 2.62 | 2.62 |
| Young’s modulus [GPa] | 74 | 76 | - | - | - | - | 74 | 75 | 76 | 76 |
| εᵣ@10 GHz (1° C./min slow cooling) @SPDR method [-] | 6.94 | 5.38 | | | | | | | 5.71 | 5.77 |
| tan δ@10 GHz (1° C./min slow cooling) @SPDR method [-] | 0.0125 | 0.0049 | - | - | - | - | - | - | 0.0040 | 0.0042 |
| Tv@2.00 mmt (ISO-9050:2003) [%] | 86 | 91 | - | - | - | - | 52 | 10 | 80 | 81 |
| Tts@2.00 mmt (ISO-13837:2008) [%] | 78 | 90 | - | - | - | - | 65 | 53 | 76 | 76 |
| Tuv@2.00mmt (ISO-9050:2003) [%] | 47 | 67 | - | - | - | - | 0 | 0 | 13 | 15 |
| a* (D65)@2.00 mmt | -2.6 | -0.2 | - | - | - | - | -2.7 | 32.8 | -2.0 | -2.0 |
| b* (D65)@2.00 mmt | 0.3 | 0.3 | - | - | - | - | 57.3 | 60.5 | 2.5 | 2.4 |

TABLE 2

| mol% | Example 11 | Example 12 | Example 13 | Example 14 | Example 15 | Example 16 | Example 17 | Example 18 | Example 19 | Example 20 |
|---|---|---|---|---|---|---|---|---|---|---|
| SiO₂ | 65.86 | 63.97 | 63.89 | 63.89 | 63.86 | 63.86 | 63.86 | 63.86 | 63.86 | 63.86 |
| Al₂O₃ | 6.98 | 7.00 | 6.99 | 6.99 | 6.98 | 6.98 | 6.98 | 6.98 | 6.98 | 6.98 |
| B₂O₃ | 7.98 | 10.00 | 9.98 | 9.98 | 9.98 | 9.98 | 9.98 | 9.98 | 9.98 | 9.98 |
| P₂O₅ | 0.00 | 0.00 | 0.00 | 0.00 | 0.00 | 0.00 | 0.00 | 0.00 | 0.00 | 0.00 |
| MgO | 4.74 | 4.75 | 4.74 | 4.74 | 4.74 | 4.74 | 4.74 | 4.74 | 4.74 | 4.74 |
| CaO | 4.74 | 4.75 | 4.74 | 4.74 | 4.74 | 4.74 | 4.74 | 4.74 | 4.74 | 4.74 |
| SrO | 4.74 | 4.75 | 4.74 | 4.74 | 4.74 | 4.74 | 4.74 | 4.74 | 4.74 | 4.74 |
| BaO | 4.74 | 4.75 | 4.74 | 4.74 | 4.74 | 4.74 | 4.74 | 4.74 | 4.74 | 4.74 |
| ZnO | 0.00 | 0.00 | 0.00 | 0.00 | 0.00 | 0.00 | 0.00 | 0.00 | 0.00 | 0.00 |
| Li₂O | 0.00 | 0.00 | 0.00 | 0.00 | 0.00 | 0.00 | 0.00 | 0.00 | 0.00 | 0.00 |
| Na₂O | 0.00 | 0.00 | 0.00 | 0.00 | 0.00 | 0.00 | 0.00 | 0.00 | 0.00 | 0.00 |
| K₂O | 0.00 | 0.00 | 0.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 |
| Fe₂O₃ | 0.22 | 0.043 | 0.17 | 0.17 | 0.22 | 0.22 | 0.22 | 0.22 | 0.22 | 0.22 |
| In total | 100 | 100 | 100 | 100 | 100 | 100 | 100 | 100 | 100 | 100 |
| C [wt%] outer percentage | 0.00 | 0.00 | 0.08 | 0.08 | 0.00 | 0.00 | 0.05 | 0.05 | 0.10 | 0.10 |
| F [wt%] outer percentage | 0.16 | 0.00 | 0.16 | 0.16 | 0.16 | 0.16 | 0.16 | 0.16 | 0.16 | 0.16 |
| SO₃ [wt%] outer percentage | 0.32 | 0.32 | 0.32 | 0.32 | 0.32 | 0.32 | 0.32 | 0.32 | 0.32 | 0.32 |
| RO | 19.0 | 19.0 | 19.0 | 19.0 | 19.0 | 19.0 | 19.0 | 19.0 | 19.0 | 19.0 |
| R₂O | 0.0 | 0.0 | 0.0 | 0.0 | 0.0 | 0.0 | 0.0 | 0.0 | 0.0 | 0.0 |
| SiO₂ + Al₂O₃ + B₂O₃ | 80.8 | 81.0 | 80.9 | 80.9 | 80.8 | 80.8 | 80.8 | 80.8 | 80.8 | 80.8 |
| B₂O₃ - Al₂O₃ | 1.0 | 3.0 | 3.0 | 3.0 | 3.0 | 3.0 | 3.0 | 3.0 | 3.0 | 3.0 |
| Al₂O₃/RO | 0.37 | 0.37 | 0.37 | 0.37 | 0.37 | 0.37 | 0.37 | 0.37 | 0.37 | 0.37 |
| Thickness [mm] | 2.00 | 2.00 | 2.00 | 1.86 | 2.00 | 1.86 | 2.00 | 1.86 | 2.00 | 1.86 |
| T_{g} (TMA) [°C] | 669 | 664 | 664 | 664 | 664 | 664 | 664 | 664 | 664 | 664 |
| CTE (50 to 350) [× 10^-7/K] | 47 | 47 | 47 | 47 | 47 | 47 | 47 | 47 | 47 | 47 |
| Softening point_T_{7.65} [°C] | ≤ 900 | 861 | 861 | 861 | 861 | 861 | 861 | 861 | 861 | 861 |
| T₁₂ [°C] | 720 | 713 | 713 | 713 | 713 | 713 | 713 | 713 | 713 | 713 |
| T₂ [°C] | ≤ 1640 | 1535 | 1535 | 1535 | 1535 | 1535 | 1535 | 1535 | 1535 | 1535 |
| T₄ [°C] | ≤ 1250 | 1165 | 1165 | 1165 | 1165 | 1165 | 1165 | 1165 | 1165 | 1165 |
| Density [g/cm³] | 2.69 | 2.69 | 2.69 | 2.69 | 2.69 | 2.69 | 2.69 | 2.69 | 2.69 | 2.69 |
| Young’s modulus [GPa] | 78 | 78 | 78 | 78 | 78 | 78 | 78 | 78 | 78 | 78 |
| εᵣ@10 GHz (1° C./min slow cooling) @SPDR method [-] | 5.86 | 5.85 | 5.85 | 5.85 | 5.85 | 5.85 | 5.85 | 5.85 | 5.85 | 5.85 |
| tan δ@10 GHz (1° C./min slow cooling) @SPDR method [-] | 0.0045 | 0.0044 | 0.0044 | 0.0044 | 0.0044 | 0.0044 | 0.0044 | 0.0044 | 0.0044 | 0.0044 |
| Tv@2.00 mmt (ISO-9050:2003) [%] | 81 | ≥ 75 | 84 | 84 | 81 | 81 | 81 | 81 | 81 | 81 |
| Tts@2.00 mmt (ISO-13837:2008) [%] | 76 | ≤ 88 | 78 | 78 | 76 | 76 | 75 | 75 | 73 | 73 |
| Tuv@2.00 mmt (ISO-9050:2003) [%] | 15 | ≤ 40 | 20 | 20 | 14 | 14 | 15 | 15 | 19 | 19 |
| a* (D65)@2.00 mmt | -2.1 | -5.0 to 0 | -1.7 | -1.7 | -2.0 | -2.0 | -2.0 | -2.0 | -2.2 | -2.2 |
| b* (D65)@2.00 mmt | 2.1 | -5.0 to 5.0 | 1.3 | 1.3 | 2.2 | 2.2 | 2.0 | 2.0 | 1.1 | 1.1 |

TABLE 3

| mol% | Example 21 | Example 22 | Example 23 | Example 24 | Example 25 | Example 26 | Example 27 | Example 28 | Example 29 | Example 30 |
|---|---|---|---|---|---|---|---|---|---|---|
| SiO₂ | 63.86 | 63.86 | 62.86 | 63.86 | 59.87 | 59.87 | 59.87 | 59.87 | 59.87 | 59.87 |
| Al₂O₃ | 6.98 | 6.98 | 6.98 | 6.98 | 6.98 | 6.98 | 6.98 | 6.98 | 6.98 | 6.98 |
| B₂O₃ | 9.98 | 9.98 | 10.98 | 9.98 | 10.98 | 10.98 | 10.98 | 10.98 | 10.98 | 10.98 |
| P₂O₅ | 0.00 | 0.00 | 0.00 | 0.00 | 0.00 | 0.00 | 0.00 | 0.00 | 0.00 | 0.00 |
| MgO | 4.74 | 4.64 | 4.75 | 4.24 | 5.49 | 5.49 | 5.49 | 5.49 | 5.49 | 5.49 |
| CaO | 4.74 | 4.64 | 4.75 | 4.24 | 5.49 | 5.49 | 5.49 | 5.49 | 5.49 | 5.49 |
| SrO | 4.74 | 4.64 | 4.75 | 4.24 | 5.49 | 5.49 | 5.49 | 5.49 | 5.49 | 5.49 |
| BaO | 4.74 | 4.64 | 4.75 | 4.24 | 5.49 | 5.49 | 5.49 | 5.49 | 5.49 | 5.49 |
| ZnO | 0.00 | 0.00 | 0.00 | 2.00 | 0.00 | 0.00 | 0.00 | 0.00 | 0.00 | 0.00 |
| Li₂O | 0.00 | 0.40 | 0.00 | 0.00 | 0.00 | 0.00 | 0.00 | 0.00 | 0.00 | 0.00 |
| Na₂O | 0.00 | 0.00 | 0.00 | 0.00 | 0.00 | 0.00 | 0.00 | 0.00 | 0.00 | 0.00 |
| K₂O | 0.00 | 0.00 | 0.00 | 0.00 | 0.00 | 0.00 | 0.00 | 0.00 | 0.00 | 0.00 |
| ZrO₂ | 0.00 | 0.00 | 0.00 | 0.00 | 0.00 | 0.00 | 0.00 | 0.00 | 0.00 | 0.00 |
| Fe₂O₃ | 0.22 | 0.22 | 0.22 | 0.22 | 0.22 | 0.22 | 0.22 | 0.22 | 0.22 | 0.22 |
| In total | 100 | 100 | 100 | 100 | 100 | 100 | 100 | 100 | 100 | 100 |
| C [wt%] outer percentage | 0.10 | 0.00 | 0.00 | 0.00 | 0.00 | 0.00 | 0.10 | 0.10 | 0.10 | 0.10 |
| F [wt%] outer percentage | 0.16 | 0.16 | 0.16 | 0.16 | 0.16 | 0.16 | 0.16 | 0.16 | 0.16 | 0.16 |
| SO₃ [wt%] outer percentage | 0.32 | 0.32 | 0.32 | 0.32 | 0.32 | 0.32 | 0.32 | 0.32 | 0.32 | 0.32 |
| RO | 19.0 | 18.6 | 19.0 | 17.0 | 22.0 | 22.0 | 22.0 | 22.0 | 22.0 | 22.0 |
| R₂O | 0.0 | 0.4 | 0.0 | 0.0 | 0.0 | 0.0 | 0.0 | 0.0 | 0.0 | 0.0 |
| SiO₂ + Al₂O₃ + B₂O₃ | 80.8 | 80.8 | 80.8 | 80.8 | 77.8 | 77.8 | 77.8 | 77.8 | 77.8 | 77.8 |
| B₂O₃ - Al₂O₃ | 3.0 | 3.0 | 4.0 | 3.0 | 4.0 | 4.0 | 4.0 | 4.0 | 4.0 | 4.0 |
| Al₂O₃/RO | 0.37 | 0.38 | 0.37 | 0.41 | 0.32 | 0.32 | 0.32 | 0.32 | 0.32 | 0.32 |
| Thickness [mm] | 1.50 | 2.00 | 2.00 | 2.00 | 2.00 | 1.81 | 2.00 | 1.81 | 1.50 | 2.20 |
| T_{g} (TMA) [°C] | 664 | 645 | 665 | 652.2 | 664 | 664 | 664 | 664 | 664 | 664 |
| CTE (50 to 350) [× 10^⁻⁷/K] | 47 | 50 | 47 | 47 | 53 | 53 | 53 | 53 | 53 | 53 |
| Softening point_T_{7.65} [°C] | 861 | ≤ 900 | ≤ 900 | ≤ 900 | 832 | 832 | 832 | 832 | 832 | 832 |
| T₁₂ [°C] | 713 | ≤ 730 | 708 | 697 | 703 | 703 | 703 | 703 | 703 | 703 |
| T₂ [°C] | 1535 | ≤ 1640 | ≤ 1640 | ≤ 1640 | 1442 | 1442 | 1442 | 1442 | 1442 | 1442 |
| T₄ [°C] | 1165 | ≤ 1250 | ≤ 1250 | ≤ 1250 | 1103 | 1103 | 1103 | 1103 | 1103 | 1103 |
| Density [g/cm³] | 2.69 | 2.70 | 2.67 | 2.65 | 2.76 | 2.76 | 2.76 | 2.76 | 2.76 | 2.76 |
| Young’s modulus [GPa] | 78 | 79 | 77 | 76 | 79 | 79 | 79 | 79 | 79 | 79 |
| εᵣ@10 GHz (1° C./min slow cooling) @SPDR method [-] | 5.85 | 5.90 | 5.85 | 5.72 | 6.17 | 6.17 | 6.17 | 6.17 | 6.17 | 6.17 |
| tan δ@10 GHz (1° C./min slow cooling) @SPDR method [-] | 0.0044 | 0.0041 | 0.004385 | 0.00425 | 0.00473 | 0.00473 | 0.00473 | 0.00473 | 0.00473 | 0.00473 |
| Tv@2.00 mmt (ISO-9050:2003) [%] | 81 | 81 | 80 | 81 | 81 | 81 | 80 | 80 | 80 | 80 |
| Tts@2.00 mmt (ISO-13837:2008) [%] | 73 | 75 | 75 | 76 | 75 | 75 | 73 | 73 | 73 | 73 |
| Tuv@2.00 mmt (ISO-9050:2003) [%] | 19 | 14 | 14 | 14 | 15 | 15 | 18 | 18 | 18 | 18 |
| a* (D65)@2.00 mmt | -2.2 | -2.0 | -2.0 | -1.9 | -2.3 | -2.3 | -2.4 | -2.4 | -2.4 | -2.4 |
| b* (D65)@2.00 mmt | 1.1 | 2.1 | 2.2 | 2.2 | 1.6 | 1.6 | 1.0 | 1.0 | 1.0 | 1.0 |

TABLE 4

| mol% | Example 31 | Example 32 | Example 33 | Example 34 | Example 35 | Example 36 | Example 37 | Example 38 | Example 39 | Example 40 | Example 41 | Example 42 |
|---|---|---|---|---|---|---|---|---|---|---|---|---|
| SiO₂ | 61.86 | 59.87 | 63.86 | 63.87 | 56.87 | 61.86 | 61.86 | 59.86 | 63.86 | 63.86 | 63.86 | 61.87 |
| Al₂O₃ | 6.98 | 6.98 | 6.99 | 6.99 | 8.98 | 6.98 | 6.98 | 6.98 | 6.98 | 6.98 | 6.99 | 6.98 |
| B₂O₃ | 9.98 | 9.98 | 9.98 | 9.98 | 9.98 | 9.98 | 9.98 | 9.98 | 9.98 | 9.98 | 9.98 | 9.98 |
| P₂O₅ | 0.00 | 0.00 | 0.00 | 0.00 | 0.00 | 2.00 | 2.00 | 3.99 | 0.00 | 0.00 | 0.00 | 0.00 |
| MgO | 4.74 | 4.74 | 4.74 | 6.74 | 5.99 | 4.74 | 4.24 | 4.24 | 4.44 | 4.29 | 4.24 | 4.24 |
| CaO | 4.74 | 4.74 | 4.74 | 4.74 | 5.99 | 4.74 | 4.24 | 4.24 | 4.44 | 4.29 | 4.24 | 4.24 |
| SrO | 4.74 | 4.74 | 6.74 | 4.74 | 5.99 | 4.74 | 4.24 | 4.24 | 4.44 | 4.29 | 4.24 | 4.24 |
| BaO | 4.74 | 4.74 | 2.74 | 2.74 | 5.99 | 4.74 | 4.24 | 4.24 | 4.44 | 4.29 | 4.24 | 4.24 |
| ZnO | 2.00 | 3.99 | 0.00 | 0.00 | 0.00 | 0.00 | 2.00 | 2.00 | 0.00 | 0.00 | 0.00 | 2.00 |
| Li₂O | 0.00 | 0.00 | 0.00 | 0.00 | 0.00 | 0.00 | 0.00 | 0.00 | 0.40 | 0.60 | 2.00 | 2.00 |
| Na₂O | 0.00 | 0.00 | 0.00 | 0.00 | 0.00 | 0.00 | 0.00 | 0.00 | 0.40 | 0.60 | 0.00 | 0.00 |
| K₂O | 0.00 | 0.00 | 0.00 | 0.00 | 0.00 | 0.00 | 0.00 | 0.00 | 0.40 | 0.60 | 0.00 | 0.00 |
| ZrO₂ | 0.00 | 0.00 | 0.00 | 0.00 | 0.00 | 0.00 | 0.00 | 0.00 | 0.00 | 0.00 | 0.00 | 0.00 |
| Fe₂O₃ | 0.22 | 0.22 | 0.21 | 0.21 | 0.22 | 0.22 | 0.22 | 0.23 | 0.22 | 0.22 | 0.22 | 0.22 |
| In total | 100 | 100 | 100 | 100 | 100 | 100 | 100 | 100 | 100 | 100 | 100 | 100 |
| C [wt%] outer percentage | 0.00 | 0.00 | 0.00 | 0.00 | 0.00 | 0.00 | 0.00 | 0.00 | 0.00 | 0.00 | 0.00 | 0.00 |
| F [wt%] outer percentage | 0.16 | 0.16 | 0.16 | 0.16 | 0.16 | 0.16 | 0.16 | 0.16 | 0.16 | 0.16 | 0.16 | 0.16 |
| SO₃ [wt%] outer percentage | 0.32 | 0.32 | 0.32 | 0.32 | 0.32 | 0.32 | 0.32 | 0.32 | 0.32 | 0.32 | 0.32 | 0.32 |
| RO | 19.0 | 19.0 | 19.0 | 19.0 | 23.9 | 19.0 | 17.0 | 17.0 | 17.8 | 17.2 | 17.0 | 17.0 |
| R₂O | 0.0 | 0.0 | 0.0 | 0.0 | 0.0 | 0.0 | 0.0 | 0.0 | 1.2 | 1.8 | 2.0 | 2.0 |
| SiO₂ + Al₂O₃ + B₂O₃ | 78.8 | 76.8 | 80.8 | 80.8 | 75.8 | 78.8 | 78.8 | 76.8 | 80.8 | 80.8 | 80.8 | 78.8 |
| B₂O₃ - Al₂O₃ | 3.0 | 3.0 | 3.0 | 3.0 | 1.0 | 3.0 | 3.0 | 3.0 | 3.0 | 3.0 | 3.0 | 3.0 |
| Al₂O₃/RO | 0.37 | 0.37 | 0.37 | 0.37 | 0.38 | 0.37 | 0.41 | 0.41 | 0.39 | 0.41 | 0.41 | 0.41 |
| Thickness [mm] | 2.00 | 2.00 | 2.00 | 2.00 | 2.00 | 2.00 | 2.00 | 2.00 | 2.00 | 2.00 | 2.00 | 2.00 |
| T_{g} (TMA) [°C] | 652 | 654 | 665 | 668 | ≤ 700 | 668 | 642 | ≤ 700 | ≤ 700 | ≤ 700 | 614 | 610 |
| CTE (50 to 350) [× 10^-7/K] | 50 | 49 | 48 | 45 | ≥ 40 | 52 | 49 | ≥ 40 | ≥ 40 | ≥ 40 | 47 | 55 |
| Softening point_T_{7.65} [°C] | ≤ 900 | ≤ 900 | ≤ 900 | ≤ 900 | ≤ 900 | ≤ 900 | ≤ 900 | ≤ 900 | ≤ 900 | ≤ 900 | ≤ 900 | ≤ 900 |
| T₁₂ [°C] | 697 | 697 | 708 | 719 | ≤ 730 | ≤ 730 | ≤ 730 | ≤ 730 | ≤ 730 | ≤ 730 | 652 | 648 |
| T₂ [°C] | ≤ 1640 | ≤ 1640 | ≤ 1640 | ≤ 1640 | ≤ 1640 | ≤ 1640 | ≤ 1640 | ≤ 1640 | ≤ 1640 | ≤ 1640 | ≤ 1640 | ≤ 1640 |
| T₄ [°C] | ≤ 1250 | ≤ 1250 | ≤ 1250 | ≤ 1250 | ≤ 1250 | ≤ 1250 | ≤ 1250 | ≤ 1250 | ≤ 1250 | ≤ 1250 | ≤ 1250 | ≤ 1250 |
| Density [g/cm³] | 2.72 | 2.78 | 2.66 | 2.60 | 2.4 to 2.9 | 2.66 | 2.65 | 2.4 to 2.9 | 2.4 to 2.9 | 2.4 to 2.9 | 2.67 | 2.71 |
| Young’s modulus [GPa] | 60 to 85 | 60 to 85 | 60 to 85 | 60 to 85 | 60 to 85 | 74 | 73 | 60 to 85 | 60 to 85 | 60 to 85 | 81 | 81 |
| εᵣ@10 GHz (1° C./min slow cooling) @SPDR method [-] | 5.95 | 6.03 | 5.79 | 5.58 | ≤ 6.5 | 5.73 | 5.66 | ≤ 6.5 | ≤ 6.5 | ≤ 6.5 | 5.88 | 5.97 |
| tan δ@10 GHz (1° C./min slow cooling) @SPDR method [-] | 0.0045 | 0.0048 | 0.0042 | 0.0043 | ≤ 0.009 | 0.0046 | 0.0045 | ≤ 0.009 | ≤ 0.009 | ≤ 0.009 | 0.0047 | 0.0048 |
| Tv@2.00 mmt (ISO-9050:2003) [%] | 82 | 81 | 81 | 82 | ≥ 75 | ≥ 75 | ≥ 75 | ≥ 75 | ≥ 75 | ≥ 75 | ≥ 75 | ≥ 75 |
| Tts@2.00 mmt (ISO-13837:2008) [%] | 76 | 74 | 76 | 76 | ≤ 88 | ≤ 88 | ≤ 88 | ≤ 88 | ≤ 88 | ≤ 88 | ≤ 88 | ≤ 88 |
| Tuv@2.00 mmt (ISO-9050:2003) [%] | 14 | 13 | 14 | 14 | ≤ 40 | ≤ 40 | ≤ 40 | ≤ 40 | ≤ 40 | ≤ 40 | ≤ 40 | ≤ 40 |
| a* (D65)@2.00 mmt | -2.2 | -2.3 | -2.1 | -1.9 | -5.0 to 0 | -5.0 to 0 | -5.0 to 0 | -5.0 to 0 | -5.0 to 0 | -5.0 to 0 | -5.0 to 0 | -5.0 to 0 |
| b* (D65)@2.00 mmt | 2.0 | 2.0 | 2.1 | 2.2 | -5.0 to 5.0 | -5.0 to 5.0 | -5.0 to 5.0 | -5.0 to 5.0 | -5.0 to 5.0 | -5.0 to 5.0 | -5.0 to 5.0 | -5.0 to 5.0 |

In each of the glass plates of Examples 9 to 42 corresponding to inventive examples, a relative dielectric constant (εᵣ) at a frequency of 10 GHz was 6.5 or less, and a dielectric loss tangent (tan δ) at a frequency of 10 GHz was 0.009 or less, so that good radio wave transmissibility was exhibited. In addition, it was found that a temperature T₁₂ when a viscosity η was 10¹² dPa·s was 730° C. or lower, and an average thermal expansion coefficient at 50° C. to 350° C. was 40 × 10⁻⁷ /K or more, so that bending forming at a low temperature was possible.

On the other hand, in the glass plate of Example 1 corresponding to a comparative example, a content of R₂O was large, and thus a relative dielectric constant (εᵣ) at a frequency of 10 GHz was more than 6.5, and a dielectric loss tangent (tan δ) at a frequency of 10 GHz was more than 0.009, so that radio wave transmissibility was poor.

In addition, it was found that in the glass plate of Example 2 corresponding to a comparative example, B₂O₃ - Al₂O₃ < 0.0 and Al₂O₃/RO > 0.50, and thus the T₁₂ is higher than 730° C., and an average thermal expansion coefficient at 50° C. to 350° C. was less than 40 × 10⁻ ⁷/K, so that bending formability at a low temperature was not sufficient. It was found that since a content of Fe₂O₃ was small, a total solar transmittance Tts was high, and a heat insulation property was poor.

In each of the glass plates of Examples 3 to 8 corresponding to comparative examples, Al₂O₃/RO was low, and thus cloudiness was observed in the glass plate.

### Production of Laminated Glass

Laminated glasses of Production Examples 1 to 17 were produced by the following procedure. Production Examples 1 and 2 are comparative examples, and Production Examples 3 to 17 are inventive examples.

### (Production Example 1)

A glass plate (Example 1) having a thickness of 2.00 mm and a composition shown in Table 1 was used as a first glass plate and a second glass plate. Polyvinyl butyral having a thickness of 0.76 mm was used as an interlayer. The first glass plate, the interlayer, and the second glass plate were laminated in this order, and subjected to a pressure bonding treatment (1 MPa, 130° C., 3 hours) using an autoclave to produce a laminated glass of Production Example 1. In the laminated glass of Production Example 1, a total thickness of the first glass plate, the second glass plate, and the interlayer was 4.76 mm.

### (Production Examples 2 to 17)

The laminated glasses of Production Examples 2 to 17 were produced in the same manner as in Production Example 1 except for items shown in Tables 5 and 6.

### [Optical Properties]

The visible light transmittance (Tv) was measured with a method defined by ISO-9050:2003 using a D65 light source in the same manner as described above.

The total solar transmittance (Tts) was measured with a method defined by ISO-13837:2008 convention A and measured at a wind speed of 4 m/s in the same manner as described above.

The ultraviolet transmittance (Tuv) was measured with a method defined by ISO-9050:2003 in the same manner as described above.

As for the chromaticity (a*, b*), the chromaticities a* and b* defined by JIS Z 8781-4 were measured using a D65 light source in the same manner as described above.

Results are shown in Tables 5 and 6.

### [Radio Wave Transmissibility]

For each of the laminated glasses of Production Examples 1 to 17, a radio wave transmission loss S21 when a TM wave having a frequency of 76 GHz, 77 GHz, 78 GHz, or 79 GHz was incident at an incident angle of 20°, 45°, or 60° was calculated based on the relative dielectric constant (εᵣ) and the dielectric loss tangent (tan δ) of each material used. Specifically, antennas were opposed to each other, and each of the obtained laminated glasses was placed between the antennas so that an incident angle was 0° to 60°. Then, for TM waves having a frequency of 76 GHz to 79 GHz, the radio wave transmission loss S21 was measured when a value of a case where there was no radio wave transmissive substrate at an opening of 100 mm Φ was set to 0 [dB], and radio wave transmissibility was evaluated according to the following criteria.

### Evaluation of Radio Wave Transmissibility

A: -1.5 [dB] ≤ S21
B: -2.0 [dB] ≤ S21 < -1.5 [dB]
C: -2.5 [dB] ≤ S21 < -2.0 [dB]
D: -3.0 [dB] ≤ S21 < -2.5 [dB]
E: -4.0 [dB] ≤ S21 < -3.0 [dB]
×_{:} S21 < -4.0 [dB]
Results are shown in Tables 5 and 6.

TABLE 5

| | | | | | |
|---|---|---|---|---|---|
| | | Production Example 1 | Production Example 2 | Production Example 3 | Production Example 4 |
| First glass plate | Thickness | 2.00 mm | 2.00 mm | 2.00 mm | 2.00 mm |
| | Glass material | Example 1 | Example 2 | Example 13 | Example 15 |
| Interlayer | Thickness | 0.76 mm | 0.76 mm | 0.76 mm | 0.76 mm |
| | Resin material | PVB | PVB | PVB | PVB |
| Second glass plate | Thickness | 2.00 mm | 2.00 mm | 2.00 mm | 2.00 mm |
| | Glass material | Example 1 | Example 2 | Example 13 | Example 15 |
| Optical properties | Tv (ISO-9050:2003) [%] | 80 | 91 | 77 | 72 |
| | Tts (ISO-13837:2008) [%] | 66 | 84 | 67 | 63 |
| | Tuv (ISO-9050:2003) [%] | 0.0044 | 0.0062 | 0.0023 | 0.0016 |
| | a* (D65) | -5.2 | -0.7 | -3.5 | -4.0 |
| | b* (D65) | 1.2 | 1.2 | 3.0 | 4.7 |
| Radio wave transmissibility 76 GHz-20° | | × | E | × | × |
| Radio wave transmissibility 76 GHz-45° | | × | A | D | D |
| Radio wave transmissibility 76 GHz-60° | | × | A | A | A |
| Radio wave transmissibility 77 GHz-20° | | × | E | × | × |
| Radio wave transmissibility 78 GHz-20° | | × | × | × | × |
| Radio wave transmissibility 79 GHz-20° | | × | × | × | × |
| Radio wave transmissibility 79 GHz-45° | | × | C | E | E |
| Radio wave transmissibility 79 GHz-60° | | × | A | B | B |

TABLE 5 (continued)

| | | | | | | |
|---|---|---|---|---|---|---|
| | | Production Example 5 | Production Example 6 | Production Example 7 | Production Example 8 | Production Example 9 |
| First glass plate | Thickness | 2.00 mm | 2.00 mm | 2.00 mm | 2.00 mm | 1.86 mm |
| | Glass material | Example 17 | Example 19 | Example 25 | Example 27 | Example 14 |
| Interlayer | Thickness | 0.76 mm | 0.76 mm | 0.76 mm | 0.76 mm | 0.76 mm |
| | Resin material | PVB | PVB | PVB | PVB | PVB |
| Second glass plate | Thickness | 2.00 mm | 2.00 mm | 2.00 mm | 2.00 mm | 1.86 mm |
| | Glass material | Example 17 | Example 19 | Example 25 | Example 27 | Example 14 |
| Optical properties | Tv (ISO-9050:2003) [%] | 71 | 71 | 72 | 70 | 77 |
| | Tts (ISO-13837:2008) [%] | 63 | 60 | 62 | 59 | 67 |
| | Tuv (ISO-9050:2003) [%] | 0.0017 | 0.0021 | 0.0018 | 0.0020 | 0.0025 |
| | a* (D65) | -4.0 | -4.3 | -4.5 | -4.7 | -3.3 |
| | b* (D65) | 4.2 | 2.5 | 3.6 | 2.3 | 2.9 |
| Radio wave transmissibility 76 GHz-20° | | × | × | × | × | C |
| Radio wave transmissibility 76 GHz-45° | | D | D | E | E | A |
| Radio wave transmissibility 76 GHz-60° | | A | A | B | B | A |
| Radio wave transmissibility 77 GHz-20° | | × | × | × | × | E |
| Radio wave transmissibility 78 GHz-20° | | × | × | × | × | E |
| Radio wave transmissibility 79 GHz-20° | | × | × | × | × | × |
| Radio wave transmissibility 79 GHz-45° | | E | E | × | × | B |
| Radio wave transmissibility 79 GHz-60° | | B | B | C | C | A |

TABLE 6

| | | | | | |
|---|---|---|---|---|---|
| | | Production Example 10 | Production Example 11 | Production Example 12 | Production Example 13 |
| First glass plate | Thickness | 1.86 mm | 1.86 mm | 1.86 mm | 1.81 mm |
| | Glass material | Example 16 | Example 18 | Example 20 | Example 26 |
| Interlayer | Thickness | 0.76 mm | 0.76 mm | 0.76 mm | 0.76 mm |
| | Resin material | PVB | PVB | PVB | PVB |
| Second glass plate | Thickness | 1.86 mm | 1.86 mm | 1.86 mm | 1.81 mm |
| | Glass material | Example 16 | Example 18 | Example 20 | Example 26 |
| Optical properties | Tv (ISO-9050:2003) [%] | 73 | 72 | 72 | 74 |
| | Tts (ISO-13837:2008) [%] | 64 | 64 | 61 | 63 |
| | Tuv (ISO-9050:2003) [%] | 0.0017 | 0.0019 | 0.0023 | 0.0020 |
| | a* (D65) | -3.8 | -3.8 | -4.1 | -4.2 |
| | b* (D65) | 4.5 | 4.0 | 2.4 | 3.3 |
| Radio wave transmissibility 76 GHz-20° | | C | C | C | D |
| Radio wave transmissibility 76 GHz-45° | | A | A | A | A |
| Radio wave transmissibility 76 GHz-60° | | A | A | A | A |
| Radio wave transmissibility 77 GHz-20° | | E | E | E | E |
| Radio wave transmissibility 78 GHz-20° | | E | E | E | × |
| Radio wave transmissibility 79 GHz-20° | | × | × | × | × |
| Radio wave transmissibility 79 GHz-45° | | B | B | B | C |
| Radio wave transmissibility 79 GHz-60° | | A | A | A | A |

TABLE 6 (continued)

| | | | | | |
|---|---|---|---|---|---|
| | | Production Example 14 | Production Example 15 | Production Example 16 | Production Example 17 |
| First glass plate | Thickness | 1.81 mm | 1.50 mm | 1.50 mm | 2.20 mm |
| | Glass material | Example 28 | Example 21 | Example 29 | Example 30 |
| Interlayer | Thickness | 0.76 mm | 0.76 mm | 0.76 mm | 0.76 mm |
| | Resin material | PVB | PVB | PVB | PVB |
| Second glass plate | Thickness | 1.81 mm | 1.50 mm | 1.50 mm | 2.20 mm |
| | Glass material | Example 28 | Example 21 | Example 29 | Example 30 |
| Optical properties | Tv (ISO-9050:2003) [%] | 72 | 75 | 75 | 68 |
| | Tts (ISO-13837:2008) [%] | 61 | 65 | 64 | 57 |
| | Tuv (ISO-9050:2003) [%] | 0.0023 | 0.0028 | 0.0027 | 0.0018 |
| | a* (D65) | -4.3 | -3.4 | -3.7 | -5.1 |
| | b* (D65) | 2.2 | 2.1 | 2.0 | 2.4 |
| Radio wave transmissibility 76 GHz-20° | | D | A | A | B |
| Radio wave transmissibility 76 GHz-45° | | A | A | A | D |
| Radio wave transmissibility 76 GHz-60° | | A | A | A | B |
| Radio wave transmissibility 77 GHz-20° | | E | A | A | A |
| Radio wave transmissibility 78 GHz-20° | | × | A | A | A |
| Radio wave transmissibility 79 GHz-20° | | × | A | A | A |
| Radio wave transmissibility 79 GHz-45° | | C | A | A | B |
| Radio wave transmissibility 79 GHz-60° | | A | A | A | B |

In each of the laminated glasses of Production Examples 3 to 17 corresponding to inventive examples, the total solar transmittance Tts was 70% or less, and a good heat insulation property was exhibited.

In each of the laminated glasses of Production Examples 3 to 17, a maximum value of the radio wave transmission loss S21 at a frequency of 76 GHz, 77 GHz, 78 GHz, or 79 GHz at an incident angle of 20°, 45°, or 60° was -4.0 dB or more, and radio wave transmissibility was excellent.

As described above, it was found that each of the laminated glasses of Production Examples 3 to 17 had high millimeter wave transmissibility and a predetermined heat insulation property.

Each of the laminated glasses of Production Examples 3 to 16 had a high visible light transmittance Tv of 70% or more, which was good. In the laminated glass of Production Example 17, the total thickness of the first glass plate, the second glass plate, and the interlayer was more than 5.00 mm, and the visible light transmittance Tv was less than 70%.

On the other hand, in the laminated glass of Production Example 1 corresponding to a comparative example, the maximum value of the radio wave transmission loss S21 at a frequency of 76 GHz, 77 GHz, 78 GHz, or 79 GHz at an incident angle of 20°, 45°, or 60° was less than -4.0 dB, and radio wave transmissibility was poor.

In the laminated glass of Production Example 2 corresponding to a comparative example, the total solar transmittance Tts was more than 70%, and a heat insulation property was poor.

Although various embodiments have been described above with reference to the drawings, it is needless to say that the present invention is not limited to such examples. It is apparent to those skilled in the art that various changes and modifications can be conceived within the scope of the claims, and it is also understood that such changes and modifications belong to the technical scope of the present invention. Constituent elements in the embodiments described above may be combined freely within a range not departing from the spirit of the invention.

The present application is based on Japanese Patent Application No. 2020-210647 filed on Dec. 18, 2020, the contents of which are incorporated herein by reference.

### REFERENCE SIGNS LIST

10: laminated glass
11: first glass plate
12: second glass plate
13: interlayer
100: automobile
110: opening
120: housing
150: back mirror
201: millimeter wave radar
202: stereo camera
300: radio wave

What is claimed is:

1. A glass plate comprising,
in terms of molar percentage based on oxides:
50% ≤ SiO₂ ≤ 80%;
5.0% ≤ Al₂O₃ ≤ 10%;
5.0% < B₂O₃ ≤ 15%;
0.0% ≤ P₂O₅ ≤ 10%;
0.0% ≤ MgO ≤ 10%;
0.0% ≤ CaO ≤ 10%;
0.0% ≤ SrO ≤ 10%;
0.0% ≤ BaO ≤ 10%;
0.0% ≤ ZnO ≤ 5.0%;
0.0% ≤ Li₂O ≤ 5.0%;
0.0% ≤ Na₂O ≤ 5.0%;
0.0% ≤ K₂O ≤ 5.0%;
0.0% ≤ R₂O ≤ 5.0%;
Fe₂O₃ ≥ 0.04%;
15% ≤ RO ≤ 30%;
B₂O₃ - Al₂O₃ > 0.0%; and
0.30 < Al₂O₃/RO < 0.50
(where R₂O represents a total amount of Li₂O, Na₂O, and K₂O, and RO represents a total amount of MgO, CaO, SrO, and BaO), wherein
the glass plate has a temperature T₁₂ at which a glass viscosity is 10¹² dPa·s of 730° C. or lower, and
the glass plate has an average thermal expansion coefficient at 50° C. to 350° C. of 40 × 10⁻⁷/K or more.

2. The glass plate according to claim 1, wherein the temperature T₁₂ is 720° C. or lower.

3. The glass plate according to claim 1, having a relative dielectric constant (εᵣ) at a frequency of 10 GHz of 6.5 or less.

4. The glass plate according to claim 1, having a dielectric loss tangent (tan δ) at a frequency of 10 GHz of 0.0090 or less.

5. The glass plate according to claim 1, having a visible light transmittance Tv defined by ISO-9050:2003 using a D65 light source when a thickness of the glass plate is converted into 2.00 mm of 75% or more.

6. The glass plate according to claim 1, having a total solar transmittance Tts defined by ISO-13837:2008 convention A and measured at a wind speed of 4 m/s when a thickness of the glass plate is converted into 2.00 mm of 88% or less.

7. The glass plate according to claim 6, wherein the total solar transmittance Tts is 80% or less.

8. The glass plate according to claim 1, comprising,
in terms of molar percentage based on oxides:
55% ≤ SiO₂ ≤ 70%;
6.0% ≤ Al₂O₃ ≤ 8.0%;
7.0% ≤ B₂O₃ ≤ 12%;
0.0% ≤ P₂O₅ ≤ 5.0%;
2.0% ≤ MgO ≤ 7.0%;
2.0% ≤ CaO ≤ 7.0%;
2.0% ≤ SrO ≤ 7.0%;
2.0% ≤ BaO ≤ 7.0%;
0.0% ≤ ZnO ≤ 3.0%;
0.04% ≤ Fe₂O₃ ≤ 0.50%;
16% ≤ RO ≤ 25%; and
0.0% ≤ R₂O ≤ 3.0%.

9. The glass plate according to claim 1, being a thermal strengthened glass.

10. A laminated glass comprising:
a first glass plate;
a second glass plate; and
an interlayer sandwiched between the first glass plate and the second glass plate, wherein
at least one of the first glass plate and the second glass plate is the glass plate according to claim 1.

11. The laminated glass according to claim 10, wherein the first glass plate, the second glass plate, and the interlayer have a total thickness of 5.00 mm or less, and
the laminated glass has a visible light transmittance Tv defined by ISO-9050:2003 using a D65 light source of 70% or more.

12. The laminated glass according to claim 10, wherein the first glass plate, the second glass plate, and the interlayer have a total thickness of 5.00 mm or less, and
the laminated glass has a total solar transmittance Tts defined by ISO-13837:2008 convention A and measured at a wind speed of 4 m/s of 70% or less.

13. The laminated glass according to claim 10, wherein the first glass plate, the second glass plate, and the interlayer have a total thickness of 5.00 mm or less, and
the laminated glass has a maximum value of a radio wave transmission loss S21 when a TM radio wave having a frequency of 75 GHz to 80 GHz is incident on the first glass plate at an incident angle of 60° of -4.0 dB or more.

14. The laminated glass according to claim 10, wherein the first glass plate, the second glass plate, and the interlayer have a total thickness of 5.00 mm or less, and
the laminated glass has a maximum value of a radio wave transmission loss S21 when a TM radio wave having a frequency of 75 GHz to 80 GHz is incident on the first glass plate at an incident angle of 45° of -4.0 dB or more.

15. The laminated glass according to claim 10, wherein the first glass plate, the second glass plate, and the interlayer have a total thickness of 5.00 mm or less, and
the laminated glass has a maximum value of a radio wave transmission loss S21 when a TM radio wave having a frequency of 75 GHz to 80 GHz is incident on the first glass plate at an incident angle of 20° of -4.0 dB or more.

16. A window glass for building, comprising the glass plate according to claim 1.

17. A window glass for vehicle, comprising the glass plate according to claim 1.

18. A window glass for vehicle, comprising the laminated glass according to claim 10.
